(19) United States
(12) Patent Application Publication
(10) Pub. No.: US 2012/0268672 A1
(43) Pub. Date: Oct. 25, 2012

(54) DISPLAY DEVICE AND BARRIER DEVICE

(75) Inventors: Sho Sakamoto, Tokyo (JP); Yuichi Inoue, Kanagawa (JP); Kenichi Takahashi, Kanagawa (JP)

(73) Assignee: Sony Corporation, Tokyo (JP)

(21) Appl. No.: 13/441,662

(22) Filed: Apr. 6, 2012

(30) Foreign Application Priority Data
Apr. 20, 2011 (JP) 2011-094163

(51) Int. Cl. G02F 1/1343; G02F 1/1335

(52) U.S. Cl. 349/15

(57) ABSTRACT

A barrier device includes: liquid crystal barriers extending in a first direction and disposed away from a display plane of a display section that displays an image. The liquid crystal barriers include a liquid crystal layer and sub-electrodes and allow light to transmit therethrough and block the light. The liquid crystal barriers structure at least one group of the liquid crystal barriers. The sub-electrodes, belonging to a first liquid crystal barrier of a pair of the liquid crystal barriers, adjoin, in a second direction, the sub-electrodes belonging to a second liquid crystal barrier in the pair of the liquid crystal barriers. The pair of the liquid crystal barriers are adjacent to each other in the at least one group of the liquid crystal barriers, and the second direction is different from both of a vertical direction and a horizontal direction within the display plane of the display section.

### BACKGROUND

The present disclosure is related to a display device of a parallax barrier type that enables a stereoscopic display, and a barrier device for use in such a display device.

In recent years, display devices capable of achieving a stereoscopic display have been attracting attention. The stereoscopic display represents left-eye images and right-eye images with parallax components (different perspectives) with respect to one another, allowing viewers to recognize those images as a stereoscopic image with a stereoscopic effect by viewing each of those images with left and right eyes. Further, display devices have been also developed that ensure to provide more natural stereoscopic images to viewers by displaying three or more images with parallax components with respect to each other.

Such display devices are roughly divided into types needing the use of dedicated eyeglasses and types eliminating the use of dedicated eyeglasses, although viewers may find the use of such dedicated eyeglasses bothersome, and thus the types eliminating the use of dedicated eyeglasses are desirable. Examples of display devices eliminating the use of dedicated eyeglasses include a lenticular lens type, a parallax barrier type, and the like. In the parallax barrier type, for example, a barrier section is provided to be laid on top of a display section, and a plurality of images (perspective images) with parallax components with respect to each other are displayed on the display section at the same time, wherein a viewer sees the images via a slit on the barrier section. This makes viewing images different depending on a relative positional relationship (angle) between a display device and viewpoints of a viewer, allowing the displayed images to be visible as more natural stereoscopic images for a viewer.

Meanwhile, for such display devices utilizing the parallax barrier method, there may be a disadvantage in that moire would arise depending on a positional relationship between a display device and a viewer. Consequently, some proposals for reducing moire have been offered for such display devices. For example, Japanese Unexamined Patent Application Publication No. 2005-86506 proposes a parallax barrier type display device wherein a slit on a barrier section is structured to extend toward an oblique direction of a display screen to reduce crosstalk and moire.

### SUMMARY

For such a display device, it is preferable that moire be almost invisible, and further reduction of moire is expected.

It is desirable to provide a display device and a barrier device that are capable of reducing moire.

A display device according to an embodiment of the present disclosure includes: a display section displaying an image; and a liquid crystal barrier section including a liquid crystal layer and a plurality of sub-electrodes, and including a plurality of liquid crystal barriers extending in a first direction. Each of the liquid crystal barriers allows light to transmit therethrough and blocks the light, and the liquid crystal barriers structure at least one group of the liquid crystal barriers. The sub-electrodes, belonging to a first liquid crystal barrier of a pair of the liquid crystal barriers, adjoin, in a second direction, the sub-electrodes belonging to a second liquid crystal barrier in the pair of the liquid crystal barriers. The pair of the liquid crystal barriers are adjacent to each other in the at least one group of the liquid crystal barriers, and the second direction is different from both of a vertical direction and a horizontal direction within a display plane of the display section.

A display device according to another embodiment of the present disclosure includes: a display section including a black matrix; and a liquid crystal barrier section including a liquid crystal layer and a plurality of sub-electrodes, and including a plurality of liquid crystal barriers. Each of the liquid crystal barriers allows light to transmit therethrough and blocks the light. Each of the sub-electrodes has a region surrounded by four sides, and each of the four sides extends in a direction different from the black matrix of the display section.

A barrier device according to an embodiment of the present disclosure includes: a plurality of liquid crystal barriers extending in a first direction and disposed away from a display plane of a display section that displays an image. The liquid crystal barriers include a liquid crystal layer and a plurality of sub-electrodes and allow light to transmit therethrough and block the light. The liquid crystal barriers structure at least one group of the liquid crystal barriers. The sub-electrodes, belonging to a first liquid crystal barrier of a pair of the liquid crystal barriers, adjoin, in a second direction, the sub-electrodes belonging to a second liquid crystal barrier in the pair of the liquid crystal barriers. The pair of the liquid crystal barriers are adjacent to each other in the at least one group of the liquid crystal barriers, and the second direction is different from both of a vertical direction and a horizontal direction within the display plane of the display section.

In the display devices and the barrier device according to the embodiments of the present disclosure described above, the liquid crystal barriers are placed into a transmission state to thereby allow a viewer to see an image displayed on the display section. The sub-electrodes, belonging to the first liquid crystal barrier of the pair of the liquid crystal barriers that are adjacent to each other in the at least one group of the liquid crystal barriers, are provided to adjoin, in the second direction which is different from both of the vertical direction and the horizontal direction, the sub-electrodes belonging to the second liquid crystal barrier in the pair of the liquid crystal barriers. In another embodiment, each of the sub-electrodes has the region surrounded by the four sides. Each of the four sides extends in the direction different from the black matrix of the display section.

According to the display devices and the barrier device of the embodiments of the present disclosure, the sub-electrodes, belonging to the first liquid crystal barrier of the pair of the liquid crystal barriers that are adjacent to each other in the at least one group of the liquid crystal barriers, adjoin the sub-electrodes belonging to the second liquid crystal barrier in the pair of the liquid crystal barriers in the second direction, or each of the sub-electrodes has the region surrounded by the four sides in which each of the four sides extends in the direction different from the black matrix of the display section. Hence, it is possible to reduce moire.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a block diagram showing a configuration example of a stereoscopic display device according to a first embodiment of the present disclosure.

FIGS. 2A and 2B are each an explanatory diagram showing a configuration example of the stereoscopic display device as shown in FIG. 1.

FIG. 3 is a block diagram showing a configuration example of a display driving section and a display section as shown in FIG. 1.

FIGS. 4A and 4B are each an explanatory diagram showing a configuration example of the display section as shown in FIG. 1.

FIG. 5 is a circuit diagram showing a configuration example of a sub-pixel as shown in FIGS. 4A and 4B.

FIGS. 6A and 6B are each an explanatory diagram showing a configuration example of a liquid crystal barrier section as shown in FIG. 1.

FIG. 7 is a plan view showing a configuration example of a transparent electrode related to the liquid crystal barrier section as shown in FIG. 1.

FIG. 8 is another plan view showing a configuration example of the transparent electrode related to the liquid crystal barrier section as shown in FIG. 1.

FIG. 9 is an explanatory diagram showing a group configuration example of opening-closing sections as shown in FIGS. 6A and 6B.

FIGS. 10A, 10B, and 10C are each a pattern diagram showing a relationship between the display section and the liquid crystal barrier section as shown in FIG. 1.

FIGS. 11A and 11B are each a pattern diagram showing an operation example of the display section and the liquid crystal barrier section as shown in FIG. 1.

FIG. 12 is another plan view showing a configuration example of the transparent electrode as shown in FIG. 7.

FIG. 13 is an explanatory diagram illustrating moire on the stereoscopic display device as shown in FIG. 1.

FIG. 14 is a plan view showing a configuration example of a transparent electrode according to a comparative example.

FIG. 15 is another plan view showing a configuration example of a transparent electrode according to a comparative example.

FIGS. 16A and 16B are each an explanatory diagram illustrating moire on a stereoscopic display device according to the comparative example as shown in FIG. 14.

FIG. 17 is a plan view showing a configuration example of a transparent electrode according to a second embodiment of the present disclosure.

FIG. 18 is another plan view showing a configuration example of the transparent electrode as shown in FIG. 17.

FIG. 19 is a plan view showing a configuration example of a transparent electrode according to a modification for the second embodiment of the present disclosure.

FIG. 20 is a plan view showing a configuration example of a transparent electrode according to another modification for the second embodiment of the present disclosure.

FIG. 21 is a plan view showing a configuration example of a transparent electrode according to a third embodiment of the present disclosure.

FIG. 22 is another plan view showing a configuration example of the transparent electrode as shown in FIG. 21.

FIG. 23 is a plan view showing a configuration example of a transparent electrode according to a modification for the third embodiment of the present disclosure.

FIG. 24 is a plan view showing a configuration example of a transparent electrode according to a fourth embodiment of the present disclosure.

FIG. 25 is a plan view showing a configuration example of a transparent electrode according to a modification for the fourth embodiment of the present disclosure.

FIGS. 26A and 26B are each an explanatory diagram showing a configuration example of a stereoscopic display device according to a modification.

FIGS. 27A and 27B are each a pattern diagram showing an operation example of a stereoscopic display device according to a modification.

FIGS. 28A, 28B, and 28C are each a pattern diagram showing an operation example of a display section and a liquid crystal barrier section according to another modification.

FIG. 29 is a plan view showing a configuration example of a transparent electrode according to another modification.

FIG. 30 is a plan view showing a configuration example of a transparent electrode according to another modification.

### DETAILED DESCRIPTION

Hereinafter, embodiments of the present disclosure are described in details with reference to the drawings. It is to be noted that the descriptions are provided in order given below.

1. First embodiment
2. Second embodiment
3. Third embodiment
4. Fourth embodiment

### 1. First Embodiment

### Configuration Example

### Overall Configuration Example

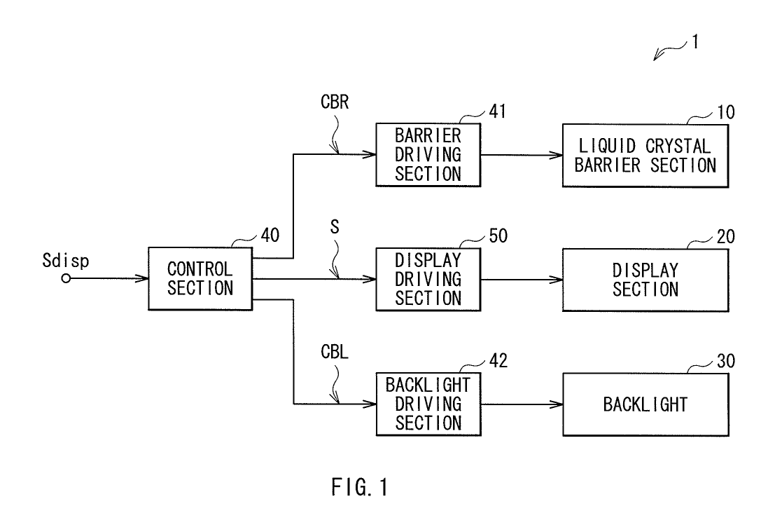

FIG. 1 shows a configuration example of a stereoscopic display device according to a first embodiment of the present disclosure. It is to be noted that a barrier device according to an embodiment of the present disclosure is also described in addition because such a barrier device is embodied with this embodiment of the present disclosure. A stereoscopic display device 1 includes a control section 40, a display driving section 50, a display section 20, a backlight driving section 42, a backlight 30, a barrier driving section 41, and a liquid crystal barrier section 10.

The control section 40 is a circuit that provides a control signal to each of the display driving section 50, the backlight driving section 42, and the barrier driving section 41 based on an image signal Sdisp provided externally for controlling these sections to operate in synchronization with each other. Specifically, the control section 40 provides an image signal S based on the image signal Sdisp to the display driving section 50, and delivers a backlight control signal CBL to the backlight driving section 42, while providing a barrier control signal CBR to the barrier driving section 41. With this arrangement, when the stereoscopic display device 1 carries out a stereoscopic display operation, as described later, the image signal S is composed of image signals SA and SB each including a plurality of perspective images (six images in this example).

The display driving section 50 drives the display section 20 on the basis of the image signal S provided from the control section 40. The display section 20 is a liquid crystal display section in this example, performing a display operation in a manner to modulate light emitted from the backlight 30 by driving liquid crystal display elements.

The backlight driving section 42 drives the backlight 30 based on the backlight control signal CBL provided from the control section 40. The backlight 30 has a function to project plane-emitting light to the display section 20. The backlight 30 is composed by the use of, for example, an LED (Light Emitting Diode), a CCFL (Cold Cathode Fluorescent Lamp), and the like.

The barrier driving section 41 drives the liquid crystal barrier section 10 based on the barrier control signal CBR provided from the control section 40. The liquid crystal barrier section 10 puts the light that is projected from the backlight 30 to transmit through the display section 20 in a transmission state (open operation) or a blocking state (closed operation), having a plurality of opening-closing sections 11 and 12 (to be described later) that are composed by the use of a liquid crystal material.

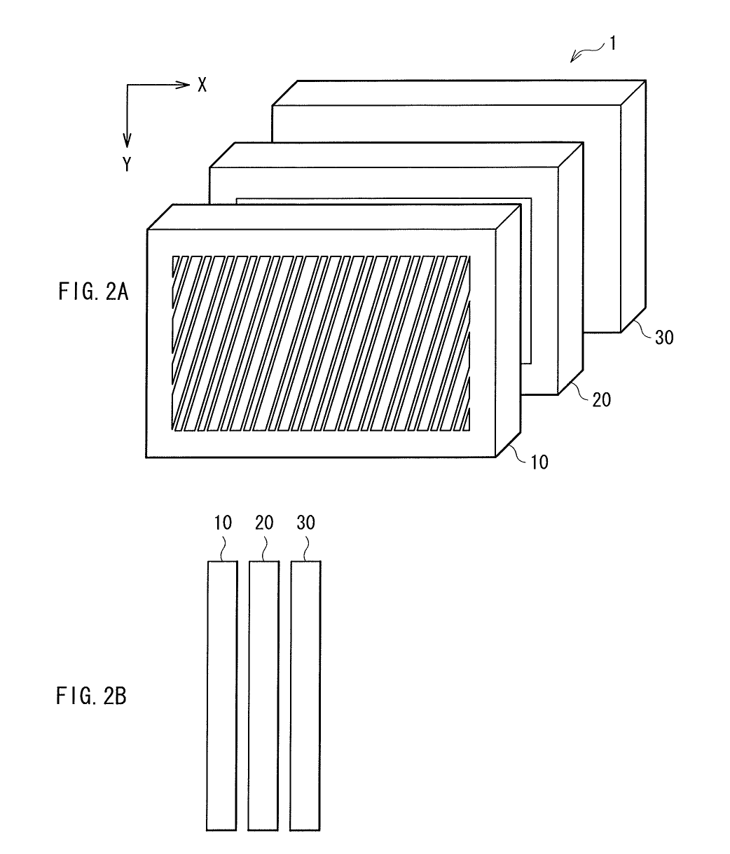

FIGS. 2A and 2B each show a configuration example of a relevant part on the stereoscopic display device 1, wherein FIG. 2A denotes an exploded perspective view of the stereoscopic display device 1, while FIG. 2B denotes a side view of the stereoscopic display device 1. As shown in FIGS. 2A and 2B, on the stereoscopic display device 1, each of these parts is disposed in the order of the backlight 30, the display section 20, and the liquid crystal barrier section 10. That is, the light projected from the backlight 30 reaches a viewer via the display section 20 and the liquid crystal barrier section 10.

### (Display Driving Section 50 and Display Section 20)

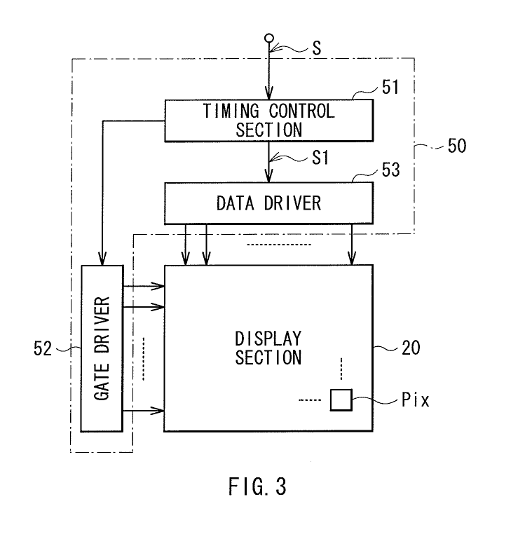

FIG. 3 shows an example of a block diagram for the display driving section 50 and the display section 20. The display driving section 50 includes a timing control section 51, a gate driver 52, and a data driver 53. The timing control section 51 controls a drive timing for the gate driver 52 and the data driver 53, while providing the image signal S delivered from the control section 40 to the data driver 53 as an image signal 51. The gate driver 52 sequentially selects pixels Pix within the display section 20 for each row for line-sequential scanning under a timing control performed by a timing control section 51. The data driver 53 provides a pixel signal based on the image signal S1 to each of the pixels Pix within the display section 20. Specifically, the data driver 53 generates the pixel signal in an analog signal form by performing D/A (digital/analog) conversion based on the image signal 51, providing the resultant pixel signal to each of the pixels Pix.

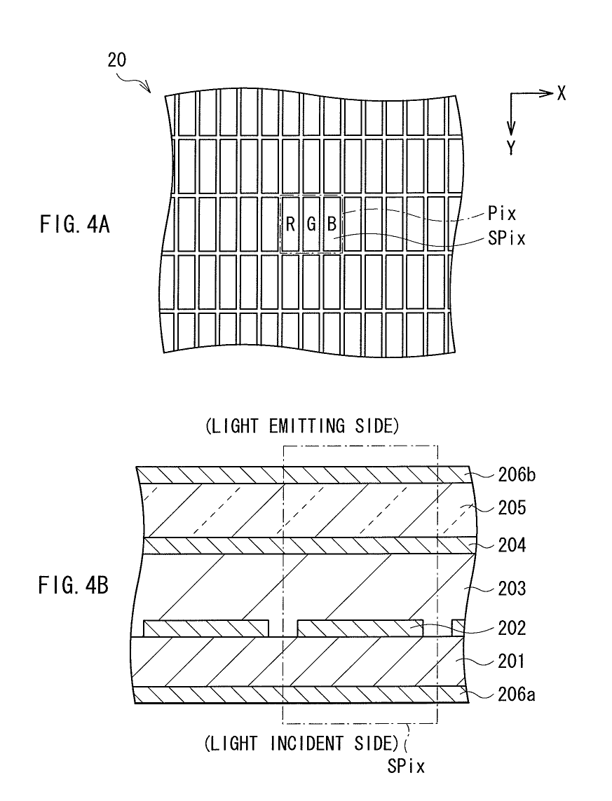

FIGS. 4A and 4B each show a configuration example of the display section 20, wherein FIG. 4A denotes an array of pixels, while FIG. 4B denotes a cross-sectional structure of the display section 20.

As shown in FIG. 4A, pixels Pix are arranged in a matrix pattern on the display section 20. Each of the pixels Pix has three sub-pixels SPix corresponding to red color (R), green color (G), and blue color (B), respectively. Among the sub-pixels SPix, so-called a black matrix is formed, thereby shielding the light that is projected from the backlight 30 to come into the display section 20. This makes it difficult to give rise to a color mixture of red color (R), green color (G), and blue color (B) on the display section 20.

As shown in FIG. 4B, the display section 20 seals a liquid crystal layer 203 between a drive substrate 201 and a counter substrate 205. The drive substrate 201 forms a pixel driver circuit (not shown in the figure) including the above-described TFT element Tr, wherein a pixel electrode 202 is arranged for each of the sub-pixels SPix on the drive substrate 201. On the counter substrate 205, a color filter (not shown in the figure) each corresponding to red color (R), green color (G), and blue color (B), as well as the black matrix (not shown in the figure) is formed, and further on the surface of the liquid crystal layer 203 side, a counter electrode 204 is arranged as an electrode common to each of the sub-pixels SPix. At the light incident side (backlight 30 side in this case) and the light emitting side (liquid crystal barrier section 10 side in this case) on the display section 20, polarizing plates 206a and 206b are attached to one another to become a cross-nicol or parallel-nicol with each other.

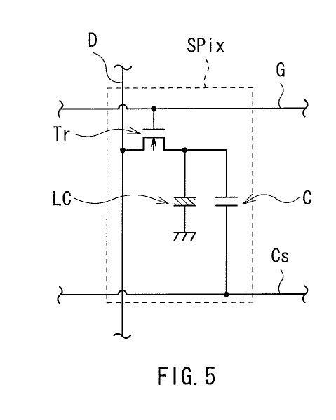

FIG. 5 shows an example of a circuit diagram for the sub-pixels SPix. The sub-pixel SPix includes a TFT (Thin Film Transistor) element Tr, a liquid crystal element LC, and a holding capacitor element Cap. The TFT element Tr is composed of, for example, a MOS-FET (Metal Oxide Semiconductor-Field Effect Transistor) with a gate connected to a gate line G, a source connected to a data line D, and a drain connected to a first end of the liquid crystal element LC and a first end of the holding capacitor element Cap, respectively. For the liquid crystal element LC, the first end is connected to the drain of the TFT element Tr, while a second end is grounded. For the holding capacitor element Cap, the first end is connected to the drain of the TFT element Tr, while a second end is connected to a holding capacitor line Cs. The gate line G is connected to the gate driver 52, and the data line D is connected to the data driver 53.

### (Liquid Crystal Barrier Section 10)

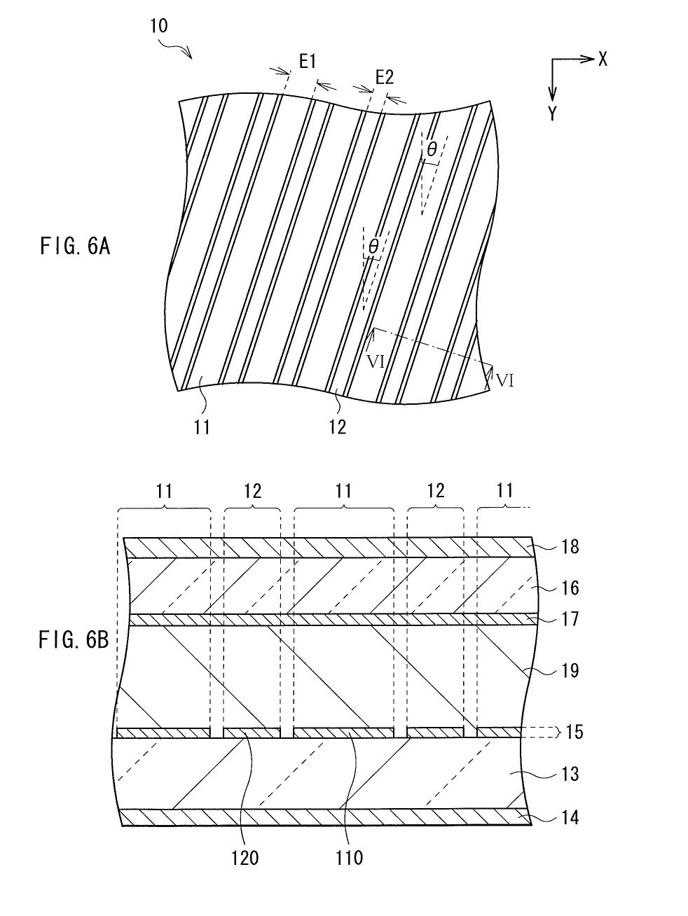

FIGS. 6A and 6B shows a configuration example of the liquid crystal barrier section 10, wherein FIG. 6A denotes an arrangement configuration of an opening-closing section on the liquid crystal barrier section 10, while FIG. 6B denotes a cross-sectional structure in the VI-VI arrow-view direction on the liquid crystal barrier section 10 shown in FIG. 6A. The liquid crystal barrier section 10 carries out a normally black operation. That is, the liquid crystal barrier section 10 blocks light in a non-driven state.

The liquid crystal barrier section 10, which is so-called a parallax barrier, has a plurality of opening-closing sections (liquid crystal barriers) 11 and 12 to transmit or block light as shown in FIG. 6A. These opening-closing sections 11 and 12 perform different operation depending on whether the stereoscopic display device 1 carries out either a normal display (two-dimensional display) or a stereoscopic display. Specifically, as described later, the opening-closing sections 11 are placed into an open state (transmission state) during a normal display, and are placed into an closed state (blocking state) during a stereoscopic display. As described later, the opening-closing sections 12 are placed into an open state (transmission state) during a normal display, and perform a switching operation on a time-division basis during a stereoscopic display.

These opening-closing sections 11 and 12 are provided to extend in one direction (for example, a direction forming a given angle θ from a vertical direction Y) on the X-Y plane. The angle θ may be set at 18 degrees for example. A width E1 of the opening-closing section 11 and a width E2 of the opening-closing section 12 are different from each other, wherein a relation of, for example, E1>E2 is maintained in this case. However, a magnitude relation in the width of the opening-closing sections 11 and 12 is not limited thereto, and a relation of E1<E2 or E1=E2 may be also permitted alternatively. Such opening-closing sections 11 and 12 include a liquid crystal layer (liquid crystal layer 19 to be described later), performing a switching operation depending on a drive voltage provided to the liquid crystal layer 19.

As shown in FIG. 6B, the liquid crystal barrier section 10 includes the liquid crystal layer 19 between a transparent substrate 13 and a transparent substrate 16 that are made of, for example, a glass. In this example, the transparent substrate 13 is disposed at the light incident side, and the transparent substrate 16 is disposed at the light emitting side. Transparent electrode layers 15 and 17 that are made of, for example, ITO are formed respectively at the surface of the liquid crystal layer 19 side on the transparent substrate 13 and at the surface of the liquid crystal layer 19 side on the transparent substrate 16. At the light incident side on the transparent substrate 13 and the light emitting side on the transparent substrate 16, polarizing plates 14 and 18 are attached to one another. For the liquid crystal layer 19, a VA (Vertical Alignment) mode liquid crystal is used for example.

The transparent electrode layer 15 has a plurality of transparent electrodes 110 and 120. The transparent electrode layer 17 is provided as an electrode common to each of the opening-closing sections 11 and 12. In this example, 0 V is applied to the transparent electrode layer 17. The transparent electrode 110 on the transparent electrode layer 15 and a portion corresponding to that transparent electrode 110 on the transparent electrode layer 17 compose the opening-closing sections 11. Similarly, the transparent electrode 120 on the transparent electrode layer 15 and a portion corresponding to that transparent electrode 120 on the transparent electrode layer 17 compose the opening-closing sections 12. At the liquid crystal layer 19 side on each of these transparent electrode layers 15 and 17, an alignment film that is not shown in the figure is formed.

The polarizing plates 14 and 18 control a polarization direction each of incoming light and outgoing light to/from the liquid crystal layer 19. A transmission axis of the polarizing plate 14 is disposed in a horizontal direction X for example, while a transmission axis of the polarizing plate 18 is disposed in a vertical direction Y for example. That is, each transmission axis of the polarizing plates 14 and 18 is disposed to be orthogonal to one another.

With such an arrangement, on the liquid crystal barrier section 10, a voltage is selectively applied to the transparent electrodes 110 and 120, and the liquid crystal layer 19 is put into a liquid crystal alignment in accordance with the applied voltage, thereby making it possible to perform a switching operation for each of the opening-closing sections 11 and 12. Specifically, when a voltage is applied to the transparent electrode layer 15 (transparent electrodes 110 and 120) and the transparent electrode layer 17, as the potential difference becomes large, the light transmittance on the liquid crystal layer 19 increases, resulting in the opening-closing sections 11 and 12 being placed into a transmission state (open state). On the other hand, as the potential difference becomes small, the light transmittance on the liquid crystal layer 19 decreases, resulting in the opening-closing sections 11 and 12 being placed into a blocking state (closed state).

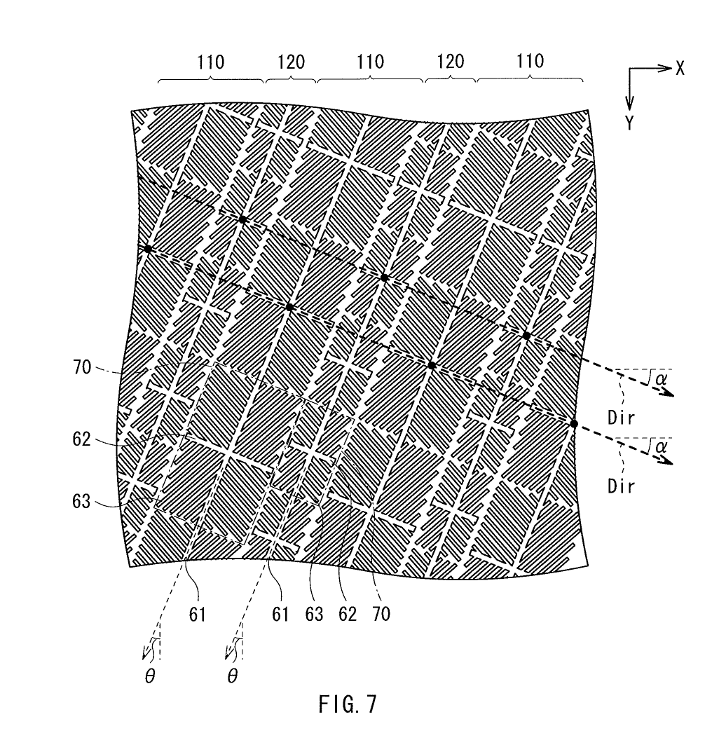

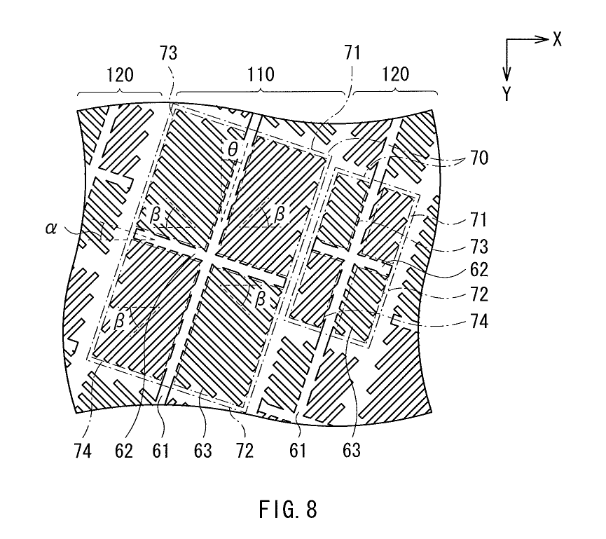

FIG. 7 and FIG. 8 show respective configuration examples for the transparent electrodes 110 and 120 on the transparent electrode layer 15.

As shown in FIG. 7, each of the transparent electrodes 110 and 120 has a stem portion 61 extending in the same direction as the extending direction of the opening-closing sections 11 and 12 (direction forming a given angle θ from a vertical direction Y). On each of the transparent electrodes 110 and 120, a sub-electrode region 70 is provided side-by-side along the extending direction of the stem portion 61. Each sub-electrode region 70 has a stem portion 62 and branch portions 63. The stem portion 62 intersects with the stem portion 61, being formed to extend in a direction forming a given angle α from a horizontal direction X. The sub-electrode region 70 is surrounded by four sides. Two sides intersecting with the stem portion 61 among four sides surrounding the sub-electrode region 70 extend in the same direction as the extending direction of the stem portion 62 (that is, direction forming a given angle α from a horizontal direction X). Further, two sides that do not intersect with the stem portion 61 among four sides surrounding the sub-electrode region 70 extend in the same direction as the extending direction of the opening-closing sections 11 and 12. It is to be noted that an angle θ is almost identical to an angle α in FIG. 7 and FIG. 8, although those angles are not limited thereto. In other words, the angle α may be equal to, or different from the angle θ.

The sub-electrode region 70 on the adjoining transparent electrode 110 is arrayed in the same direction as the extending direction of the stem portion 62 (array direction Dir), while the sub-electrode region 70 on the adjoining transparent electrode 120 is arrayed in the array direction Dir as with the sub-electrode region 70 on the adjoining transparent electrode 110. More specifically, the adjoining sub-electrode regions 70 are placed in the direction different from both of the horizontal direction X and the vertical direction Y.

As shown in FIG. 8, on each sub-electrode region 70, there are provided four branch regions (domains) 71 to 74 that are separated from the stem portion 61 and the stem portion 62. The branch portions 63 are formed to extend from the stem portions 61 and 62 in each of the branch regions 71 to 74. A line width of each of the branch portions 63 is equal to each other in the branch regions 71 to 74. Similarly, a spacing interval (slit width) of each of the branch portions 63 is also equal to each other in the branch regions 71 to 74. The branch portions 63 in each of the branch regions 71 to 74 extend in the same direction within each region. The extending direction of the branch portions 63 in the branch region 71 and the extending direction of the branch portions 63 in the branch region 73 are axisymmetric with respect to the vertical direction Y as an axis. Similarly, the extending direction of the branch portions 63 in the branch region 72 and the extending direction of the branch portions 63 in the branch region 74 are axisymmetric with respect to the vertical direction Y as an axis. Further, the extending direction of the branch portions 63 in the branch region 71 and the extending direction of the branch portions 63 in the branch region 72 are axisymmetric with respect to the horizontal direction X as an axis. Similarly, the extending direction of the branch portions 63 in the branch region 73 and the extending direction of the branch portions 63 in the branch region 74 are axisymmetric with respect to the horizontal direction X as an axis. In this example, in concrete terms, the branch portions 63 in the branch regions 71 and 74 extend in the direction rotated at a given angle β counterclockwise from the horizontal direction X, while the branch portions 63 in the branch regions 72 and 73 extend in the direction rotated at a given angle β clockwise from the horizontal direction X. It is preferable that the angle β be 45 degrees for example. With such a configuration, when a viewer watches a display screen on the stereoscopic display device 1, the viewing-field-angle property in viewing from left direction and right direction is allowed to be made symmetric, while the viewing-field-angle property in viewing from upper direction and lower direction is also allowed to be made symmetric.

On the liquid crystal barrier section 10, a plurality of the opening-closing sections 12 form groups, wherein a plurality of the opening-closing sections 12 belonging to the same group perform open and closed operations at the same timing in carrying out a stereoscopic display. Hereinafter, groups of the opening-closing sections 12 are described.

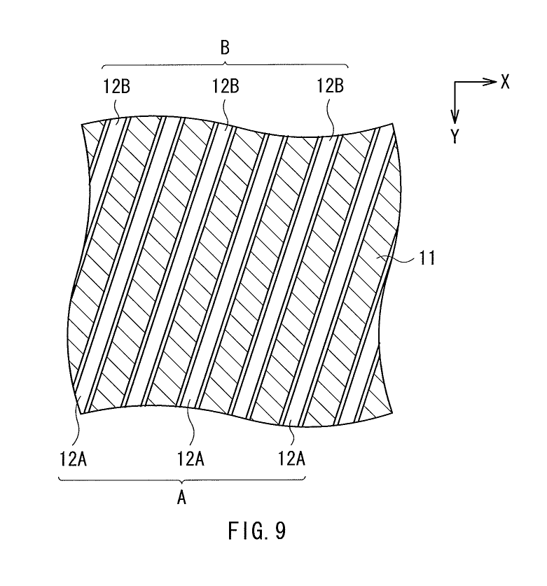

FIG. 9 shows a group configuration example of the opening-closing sections 12. In this example, the opening-closing sections 12 structure two groups (barrier sub-groups). Specifically, a plurality of the opening-closing sections 12 that are arranged side by side compose a group A and a group B alternately. It is to be noted that opening-closing sections 12A are used as appropriate as a generic term of the opening-closing sections 12 belonging to the group A, and similarly opening-closing sections 12B are used as appropriate as a generic term of the opening-closing sections 12 belonging to the group B.

The barrier driving section 41 drives a plurality of the opening-closing sections 12 belonging to the same group to perform open/closed operations at the same timing in carrying out a stereoscopic display. Specifically, as described later, the barrier driving section 41 drives a plurality of the opening-closing sections 12A belonging to the group A and a plurality of the opening-closing sections 12B belonging to the group B to perform open/closed operations alternately on a time-division basis.

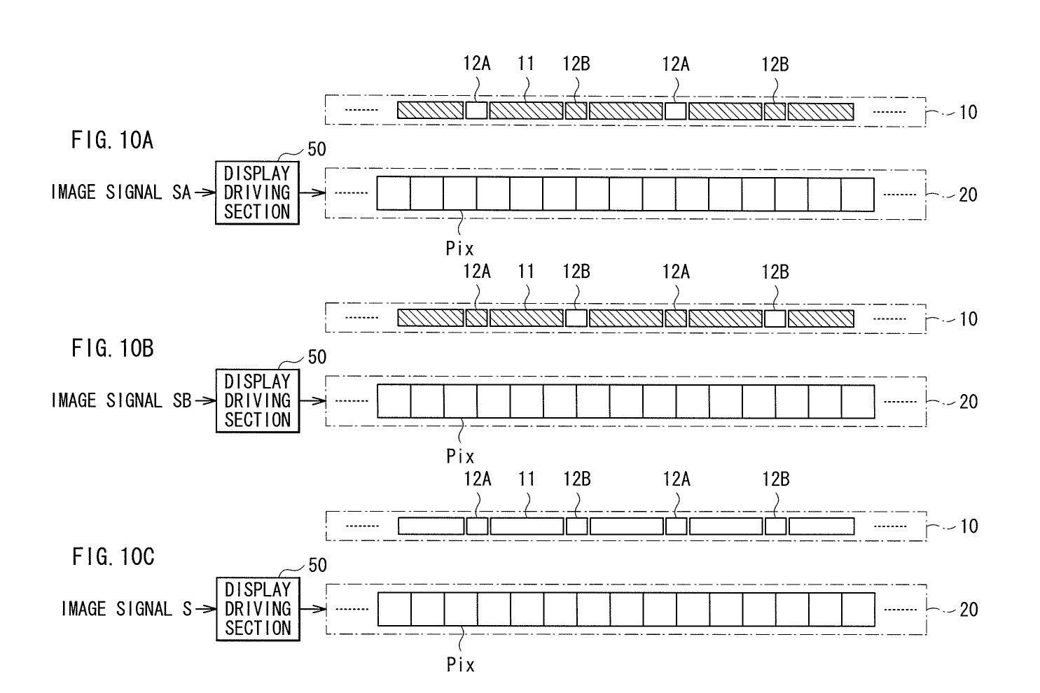

FIGS. 10A to 10C each show status of the liquid crystal barrier section 10 in carrying out a stereoscopic display and a normal display (two-dimensional display) as a pattern diagram using a cross-sectional structure, wherein FIG. 10A denotes a state in performing a stereoscopic display, and FIG. 10B denotes another state in performing a stereoscopic display, while FIG. 10C denotes a state in performing a normal display. On the liquid crystal barrier section 10, the opening-closing sections 11 and the opening-closing sections 12 (opening-closing sections 12A and 12B) are disposed alternately. In this example, the opening-closing sections 12A are provided at a rate of one piece per six pixels Pix. In the same way, the opening-closing sections 12B are provided at a rate of one piece per six pixels Pix as well. In FIGS. 10A to 10C, the opening-closing sections in which light is blocked among the opening-closing sections 11, 12A, and 12B on the liquid crystal barrier section 10 are marked with oblique lines.

In carrying out a stereoscopic display, the image signals SA and SB are alternately supplied to the display driving section 50, and the display section 20 performs a display operation based on such supplied image signals. At this time, on the liquid crystal barrier section 10, the opening-closing sections 12 (opening-closing sections 12A and 12B) perform open/closed operations on a time-division basis, while the opening-closing sections 11 are kept in a closed state (blocking state). Specifically, when the image signal SA is provided, as shown in FIG. 10A, the opening-closing sections 12A are put in an open state, while the opening-closing sections 12B are put in an closed state. On the display section 20, as described later, six pixels Pix that are arranged adjacently to each other at positions corresponding to the opening-closing sections 12A carry out a display operation corresponding to six perspective images included in the image signal SA. Consequently, as described later, a viewer sees different perspective images with a left eye and a right eye for example, feeling displayed images as a stereoscopic image. Similarly, when the image signal SB is provided, as shown in FIG. 10B, the opening-closing sections 12B are put in an open state, while the opening-closing sections 12A are put in a closed state. On the display section 20, as described later, six pixels Pix that are arranged adjacently to each other at positions corresponding to the opening-closing sections 12B carry out a display operation corresponding to six perspective images included in the image signal SB. Consequently, as described later, a viewer sees different perspective images with a left eye and a right eye for example, feeling displayed images as a stereoscopic image. On the stereoscopic display device 1, images are represented by alternately opening the opening-closing sections 12A and the opening-closing sections 12B in such a manner, thereby allowing the resolution of the display device to be improved as described later.

In carrying out a normal display (two-dimensional display), on the liquid crystal barrier section 10, both of the opening-closing sections 11 and the opening-closing sections 12 (opening-closing sections 12A and 12B) are kept in an open state (transmission state) as shown in FIG. 10C. As a result, a viewer is allowed to see normal two-dimensional images as they are that are displayed on the display section 20 based on the image signal S.

Thereupon, the opening-closing sections 11 and 12 correspond to a specific example of “liquid crystal barriers” in one embodiment of the present disclosure. The opening-closing sections 12 correspond to a specific example of a “a first group of liquid crystal barriers” in one embodiment of the present disclosure, while the opening-closing sections 11 correspond to a specific example of a “second group of liquid crystal barriers” in one embodiment of the present disclosure. The transparent electrodes 110 and 120 on the sub-electrode region 70 correspond to a specific example of “sub-electrodes” in one embodiment of the present disclosure. The array direction Dir corresponds to a specific example of a “second direction” in one embodiment of the present disclosure.

The stem portion 61 corresponds to a specific example of a “first stem portion” in one embodiment of the present disclosure. The stem portion 62 corresponds to a specific example of a “second stem portion” in one embodiment of the present disclosure. The branch regions 71 to 74 correspond to a specific example of a “first branch region”, a “second branch region”, a “third branch region”, and a “fourth branch region” respectively in one embodiment of the present disclosure. An electrode on the transparent electrode layer 17 corresponds to a specific example of a “common electrode” in one embodiment of the present disclosure.

### (Operation and Action)

Subsequently, the description is provided on the operation and action of the stereoscopic display device 1 according to the embodiment of the present disclosure.

### (Overview of Overall Operation)

First, the overview of overall operation for the stereoscopic display device 1 is described with reference to FIG. 1. The control section 40 provides the control signal to each of the display driving section 50, the backlight driving section 42, and the barrier driving section 41 based on the image signal Sdisp provided externally for controlling these sections to operate in synchronization with each other. The backlight driving section 42 drives the backlight 30 based on the backlight control signal CBL provided from the control section 40. The backlight 30 projects plane-emitting light to the display section 20. The display driving section 50 drives the display section 20 based on the image signal S provided from the control section 40. The display section 20 performs a display operation by modulating the light projected from the backlight 30. The barrier driving section 41 drives the liquid crystal barrier section 10 based on the barrier control command signal CBR provided from the control section 40. The opening-closing sections 11 and 12 (12A and 12B) on the liquid crystal barrier section 10 perform open/closed operations based on the barrier control command signal CBR, transmitting or blocking the light that is projected from the backlight 30 and transmitted through the display section 20.

### (Detailed Operation of Stereoscopic Display)

Next, the description is provided on the detailed operation in carrying out a stereoscopic display.

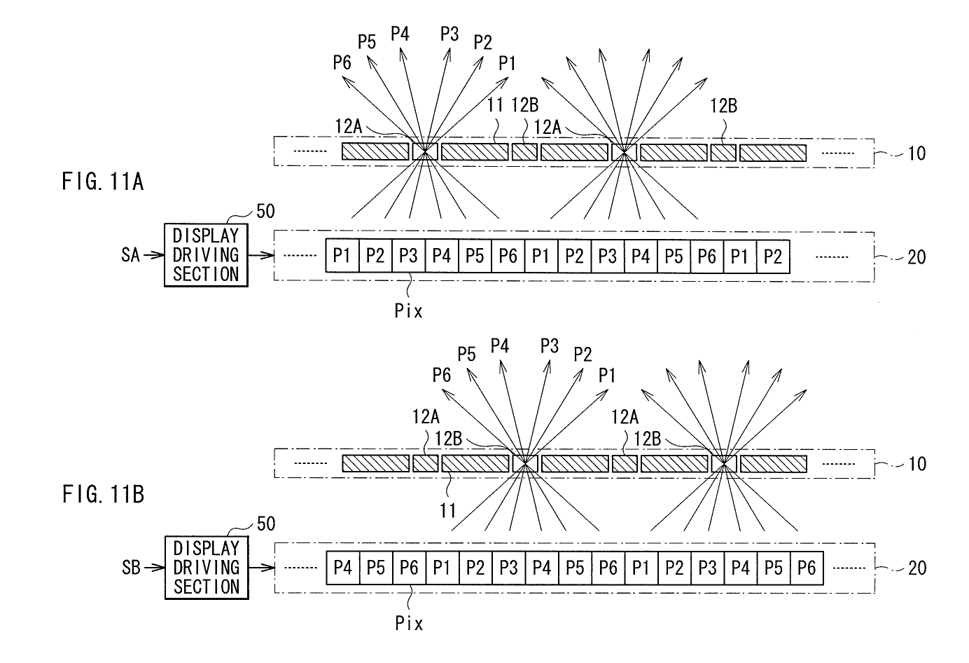

FIGS. 11A and 11B shows an operation example of the display section 20 and the liquid crystal barrier section 10, wherein FIG. 11A denotes a case where the image signal SA is provided, while FIG. 11B denotes a case where the image signal SB is provided.

When the image signal SA is provided, as shown in FIG. 11A, each of the pixels Pix on the display section 20 displays pixel information P1 to P6 corresponding to each of six perspective images included in the image signal SA. At this time, the pixel information P1 to P6 are respectively displayed at the pixels Pix arranged in the vicinity of the opening-closing sections 12A. When the image signal SA is provided, on the liquid crystal barrier section 10, control is carried out so that the opening-closing sections 12A are put in an open state (transmission state), while the opening-closing sections 12B are put in a closed state. The light outgoing from each of the pixels Pix on the display section 20 is output with its angle limited by the opening-closing sections 12A. A viewer is allowed to see a stereoscopic image by viewing the pixel information P3 with a left eye and the pixel information P4 with a right eye for example.

When the image signal SB is provided, as shown in FIG. 11B, each of the pixels Pix on the display section 20 displays pixel information P1 to P6 corresponding to each of six perspective images included in the image signal SB. At this time, the pixel information P1 to P6 are respectively displayed at the pixels Pix arranged in the vicinity of the opening-closing sections 12B. When the image signal SB is provided, on the liquid crystal barrier section 10, control is carried out so that the opening-closing sections 12B are put in an open state (transmission state), while the opening-closing sections 12A are put in a closed state. The light outgoing from each of the pixels Pix on the display section 20 is output with its angle limited by the opening-closing sections 12B. A viewer is allowed to see a stereoscopic image by viewing the pixel information P3 with a left eye and the pixel information P4 with a right eye for example.

In such a manner, a viewer sees different pixel information among the pixel information P1 to P6 with a left eye and a right eye, thereby allowing to feel such pixel information as a stereoscopic image. Further, images are displayed with the opening-closing sections 12A and the opening-closing sections 12B open alternately on the time-division basis, which enables a viewer to see averaged images displayed at positions shifted from each other. This allows the stereoscopic display device 1 to achieve the resolution twice as high as a case where only the opening-closing sections 12A are provided. In other words, the resolution required for the stereoscopic display device 1 is only one third (=⅙×2) of the case of two-dimensional display.

### (About Moire)

Next, the description is provided on the moire arising when images are displayed on the stereoscopic display device 1. First, for explanation, a case where the stereoscopic display device 1 performs a stereoscopic display operation is taken as an example.

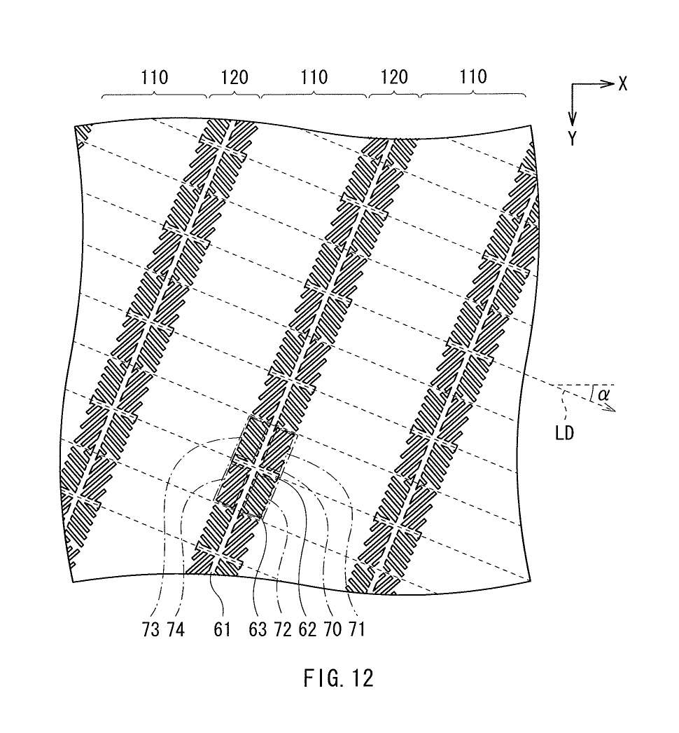

FIG. 12 shows a configuration example of the transparent electrode layer 15 related to the stereoscopic display. It is to be noted that FIG. 12 shows only the transparent electrode 120 related to the opening-closing sections 12 that perform open/closed operations on the time-division basis at the time of the stereoscopic display.

As shown in FIGS. 11A and 11B, since the sub-electrode regions 70 on the adjoining transparent electrodes 120 are placed side by side in the direction forming a given angle α from the horizontal direction X (array direction Dir), border portions of the branch regions (domains) 71 to 74 on the transparent electrodes 120 are arrayed on a single straight line (on a domain borderline LD) extending in the array direction Dir as shown in FIG. 12. Specifically, a border portion between the branch regions 71 and 73 and the branch regions 72 and 74 is arrayed on the domain borderline LD. In other words, a border portion between the stem portion 62 and the sub-electrode regions 70 adjoining in the extending direction of the opening-closing sections 12 is arrayed on the domain borderline LD. At the border portions of these branch regions (domains) 71 to 74, even if a voltage is applied between the transparent electrode layer 17 and the transparent electrode 120, light may not be transmitted sufficiently because of insufficient alignment of the liquid crystal molecules on the liquid crystal layer 19. That is, such a domain borderline LD becomes so-called a dark line.

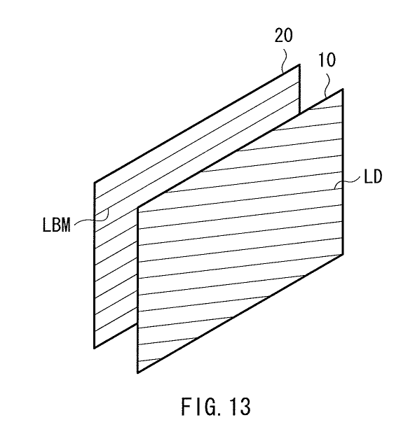

FIG. 13 shows a correlation between a black matrix on the display section 20 and the domain borderline LD on the liquid crystal barrier section 10. For convenience of explanation, FIG. 13 only shows a black matrix extending in the horizontal direction (light-shielding line LBM) among black matrixes on the display section 20.

As shown in FIG. 13, the light-shielding lines LBM on the display section 20 and the domain borderlines LD intersect with each other within a display plane on the stereoscopic display device 1. More specifically, as described above, the light-shielding lines LBM on the display section 20 extend in the horizontal direction X within a display plane, while the domain borderlines LD on the liquid crystal barrier section 10 extend in the direction forming a given angle α from the horizontal direction X (array direction Dir) within a display plane. As described hereinafter by citing an example, this makes any moire less noticeable that is caused by a cyclic property of the light-shielding lines LBM on the display section 20 and a cyclic property of the domain borderlines LD on the liquid crystal barrier section 10.

It is to be noted that the above description is provided by taking a case where the stereoscopic display device 1 performs the stereoscopic display operation as an example, although a case where the stereoscopic display device 1 performs the normal display (two-dimensional display) operation holds true as well. In the case of the normal display, since the opening-closing sections 11 are also put in an open state (transmission state) in addition to the opening-closing sections 12, it is necessary to consider the domain borderlines on the transparent electrodes 110 related to the opening-closing sections 11 in addition to the domain borderlines LD on the transparent electrodes 120 related to the opening-closing sections 12. However, on the stereoscopic display device 1, the sub-electrode regions 70 on the adjoining transparent electrodes 110 are also placed side by side in the direction forming the angle α from the horizontal direction X (array direction Dir), and accordingly the domain borderlines related to the opening-closing sections 11 also extend in the direction forming the angle α from the horizontal direction X within a display plane (array direction Dir), which makes any moire less noticeable.

### Comparative Example

Next, the action according to the embodiment of the present disclosure is described as compared with a comparative example. On a stereoscopic display device 1R according to this comparative example, the array direction Dir of the sub-pixel electrodes is set to the same direction as the horizontal direction X by setting a given angle α at 0 degree.

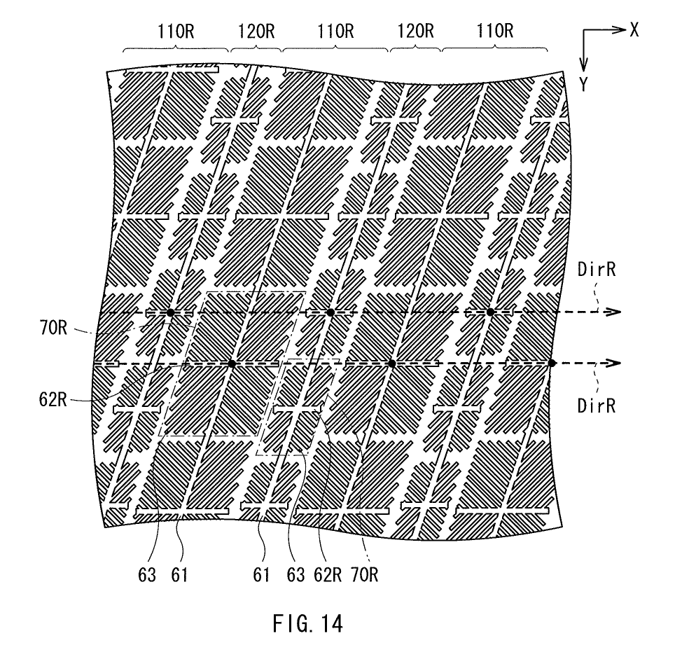

FIG. 14 shows a configuration example of transparent electrodes 110R and 120R on a liquid crystal barrier section 10R according to the comparative example. On each of the transparent electrodes 110R and 120R, sub-electrode regions 70R are placed side by side along the extending direction of the stem portions 61. Each of the sub-electrode regions 70R has a stem portion 62R. The stem portions 62R intersect with the stem portions 61, and are formed to extend in the horizontal direction X. The sub-electrode regions 70R on the adjoining transparent electrodes 110R are arrayed in the same horizontal direction X (array direction DirR) as the extending direction of the stem portions 62R, and the sub-electrode regions 70R on the adjoining transparent electrodes 120R are also arrayed in this horizontal direction X (array direction DirR) as with the sub-electrode regions 70R on the adjoining transparent electrodes 110R. On each of the sub-electrode regions 70R, four branch regions (domains) 71R to 74R are provided that are separated by the stem portions 61 and the stem portions 62R.

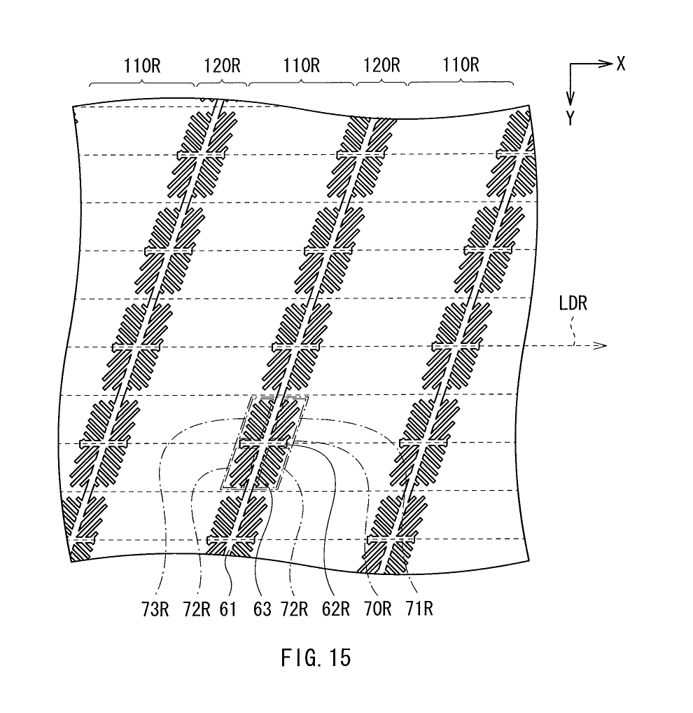

FIG. 15 shows a configuration example of the transparent electrode 120R. On the liquid crystal barrier section 10R according to this comparative example, since the sub-electrode regions 70R on the adjoining transparent electrodes 120R are arrayed in the horizontal direction X (array direction DirR), border portions of the branch regions (domains) 71R to 74R on the transparent electrodes 120R are arrayed on a single straight line (on the domain borderline LDR) extending in the horizontal direction X (array direction DirR). It is to be noted that the transparent electrode 120R is only described here, although the transparent electrode 110R holds true as well, wherein border portions of the branch regions (domains) 71R to 74R on the transparent electrodes 110R are also arrayed on a single straight line extending in the horizontal direction X (array direction DirR).

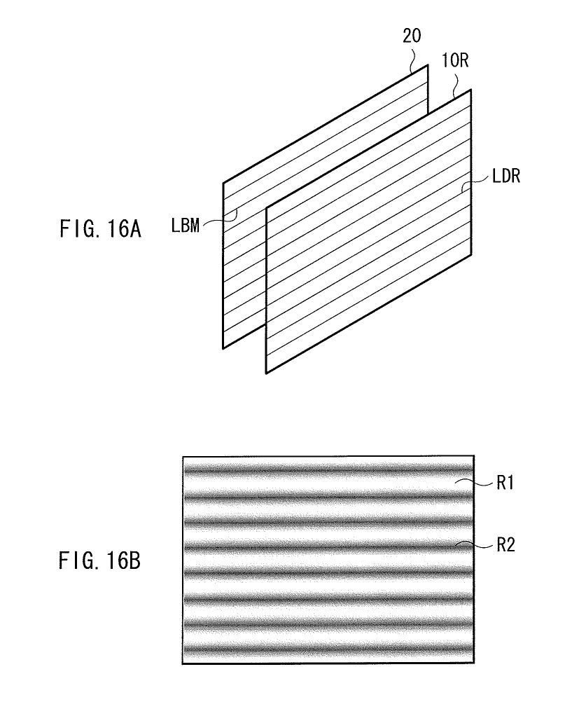

FIG. 16A shows a correlation between the light-shielding lines LBM on the display section 20 and the domain borderlines LDR on the liquid crystal barrier section 10R, while FIG. 16B shows the moire appearing on a display screen.

As shown in FIG. 16A, both of the light-shielding lines LBM on the display section 20 and the domain borderlines LDR on the liquid crystal barrier section 10R extend in the horizontal direction X within a display plane on the stereoscopic display device 1R. Further, as shown in FIGS. 2A and 2B, the display section 20 and the liquid crystal barrier section 10R are disposed side by side in the depth direction when a viewer watches the stereoscopic display device 1R. Consequently, depending on a positional relationship between the stereoscopic display device 1R and a viewer, any displacement may occur between an array cycle of the light-shielding lines LBM and an array cycle of the domain borderlines LDR in the vertical direction Y, resulting in the moire as shown in FIG. 16B being possibly perceived by a viewer. Specifically, for example, a display screen region where the domain borderlines LDR and the light-shielding lines LBM are almost overlapped with each other becomes a bright section R1, while a display screen region where the domain borderlines LDR and the light-shielding lines LBM are significantly displaced becomes a dark section R2. In such a manner, a viewer perceives a luminance difference between the bright section R1 and the dark section R2 as the moire.

As described above, on the stereoscopic display device 1R according to this comparative example, since the sub-electrode regions 70R on the adjoining transparent electrodes 120R (110R) are arrayed in the horizontal direction X (array direction DirR), the domain borderlines LDR also extend in the horizontal direction X. Therefore, due to interference between the domain borderlines LDR and the light-shielding lines LBM on the display section 20 that extend in the horizontal direction X, the moire may come up.

In contrast, on the stereoscopic display device 1 according to the embodiment of the present disclosure, since the sub-electrode regions 70 on the adjoining transparent electrodes 120 (110) are arrayed in the direction forming a given angle α from the horizontal direction X (array direction Dir), the domain borderlines LD extend in the array direction Dir. This makes it possible to reduce any interference between the domain borderlines LD and the light-shielding lines LBM on the display section 20 that extend in the horizontal direction X, resulting in the moire being made less noticeable.

### Advantageous Effects

As described above, according to this embodiment of the present disclosure, the sub-electrode regions on the adjoining transparent electrodes 120 (110) are arrayed in the direction forming a given angle α from the horizontal direction X, which allows to make any moire less noticeable.

Further, according to the embodiment of the present disclosure, the extending direction of the stem portions 62 and the array direction of the sub-electrode regions are set to be the same, which achieves more simplified electrode structure.

### 2. Second Embodiment

Next, the description is provided on a stereoscopic display device 2 according to a second embodiment of the present disclosure. In the second embodiment of the present disclosure, the extending direction of the stem portions 62 is different from the array direction Dir of the sub-electrode regions. It is to be noted that any component parts essentially same as the stereoscopic display device 1 according to the first embodiment of the present disclosure are denoted with the same reference numerals, and the related descriptions are omitted as appropriate.

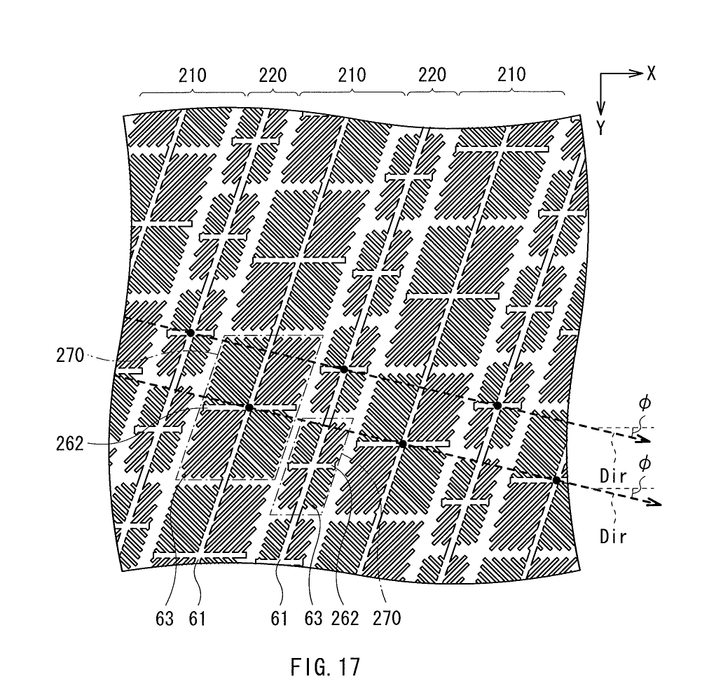

FIG. 17 shows a configuration example of transparent electrodes 210 and 220 related to the stereoscopic display device 2 according to the second embodiment of the present disclosure. On each of the transparent electrodes 210 and 220, a sub-electrode region 270 is provided side-by-side along the extending direction of the stem portion 61. Each sub-electrode region 270 has a stem portion 262. The stem portion 262 intersects with the stem portion 61, being formed to extend in the horizontal direction X. The sub-electrode regions 270 on the adjoining transparent electrodes 210 are arrayed in the direction forming a given angle φ from the horizontal direction X (array direction Dir), and the sub-electrode regions 270 on the adjoining transparent electrodes 220 are also arrayed in the array direction Dir as with the sub-electrode regions 270 on the adjoining transparent electrodes 210. On each of the sub-electrode regions 270, there are provided four branch regions (domains) 271 to 274 that are separated by the stem portions 61 and the stem portions 262.

More specifically, unlike a case of the stereoscopic display device 1 according to the first embodiment (FIG. 7), on the stereoscopic display device 2 according to the second embodiment, the stem portions 262 are formed to extend in the horizontal direction X, and the extending direction of the stem portions 262 and the array direction of the sub-electrode regions 270 are different from each other.

Further, from a viewpoint of a difference with the stereoscopic display device 1R according to the above-described comparative example, a difference is found in the array direction of the sub-electrode regions. More specifically, unlike a case of the stereoscopic display device 1R according to the comparative example (FIG. 14), on the stereoscopic display device 2 according to the second embodiment, the sub-electrode regions 270 on the adjoining transparent electrodes 220 (210) are arrayed in the direction forming a given angle φ from the horizontal direction X.

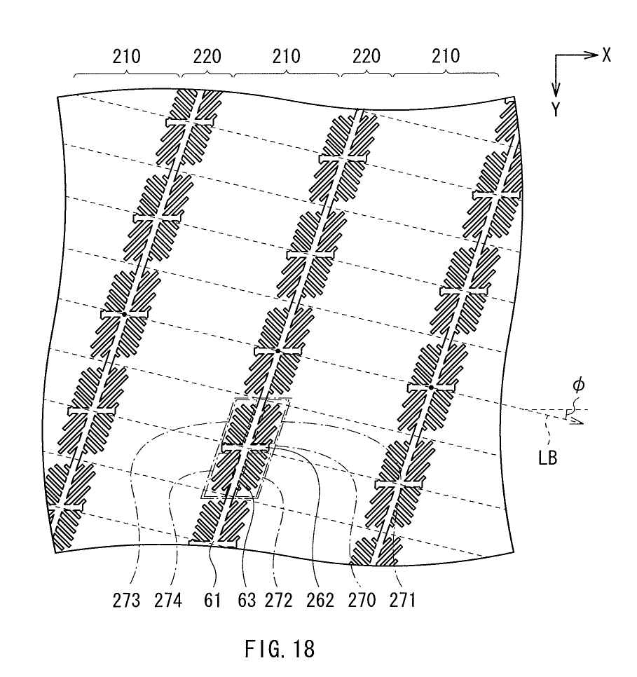

FIG. 18 shows a configuration example of the transparent electrode 220. Unlike the stereoscopic display device 1 according to the first embodiment, on the stereoscopic display device 2 according to the second embodiment, the stem portions 262 are formed to extend in the horizontal direction X. However, the sub-electrode regions 270 on the adjoining transparent electrodes 220 are arrayed in the direction forming a given angle φ from the horizontal direction X (array direction Dir). Seen from a whole display screen, therefore, border portions of the branch regions (domains) 271 to 274 on the transparent electrodes 220 are disposed at positions corresponding to a straight line (borderline LB) extending in the array direction Dir. In other words, dark lines resulting from the border portions of the branch regions (domains) 271 to 274 may arise at positions of the borderlines LB. That is, the borderlines LB correspond to the domain borderlines LD in the first embodiment.

It is to be noted that the above description is only provided on the transparent electrode 220, although the transparent electrode 210 holds true as well, wherein border portions of the branch regions (domains) 271 to 274 on the transparent electrodes 210 are also disposed at positions corresponding to a straight line (borderline LB) extending in the array direction Dir.

As described above, on the stereoscopic display device 2 according to the second embodiment, the stem portions 262 are formed to extend in the horizontal direction X, and the sub-electrode regions 270 on the adjoining transparent electrodes 220 (210) are arrayed in the direction forming a given angle φ from the horizontal direction X (array direction Dir). As a result, on the stereoscopic display device 2 according to the second embodiment, the borderlines LB corresponding to the domain borderlines LD in the first embodiment extend in the array direction Dir. This makes it possible to reduce interference between the borderlines LB and the light-shielding lines LBM on the display section 20 that extend in the horizontal direction X, thereby allowing any moire to be made less noticeable.

Further, unlike the stereoscopic display device 1 according to the first embodiment, on the stereoscopic display device 2 according to the second embodiment, it is possible to set the extending direction of the stem portions 262 and the array direction Dir of the sub-electrode regions 270 independently of each other. This ensures to enhance a degree of freedom in design. Specifically, this makes it possible to determine the array direction Dir of the sub-electrode regions 270 considering reduction of the moire, as well as to determine the extending direction of the stem portions 262 and others considering, for example, the alignment of liquid crystal at each of the branch regions 271 to 274.

As described above, according to the second embodiment, the extending direction of the stem portions 262 intersecting with the stem portions 61 and the array direction Dir of the sub-electrode regions 270 are set independently of each other, which ensures to enhance a degree of freedom in design. Any other advantageous effects are the same as with the first embodiment.

### (Modification 2-1)

According to the above second embodiment, the stem portions 262 extend in the horizontal direction X, although the embodiment is not limited thereto, and any other directions may be permitted alternatively. An example is described hereinafter.

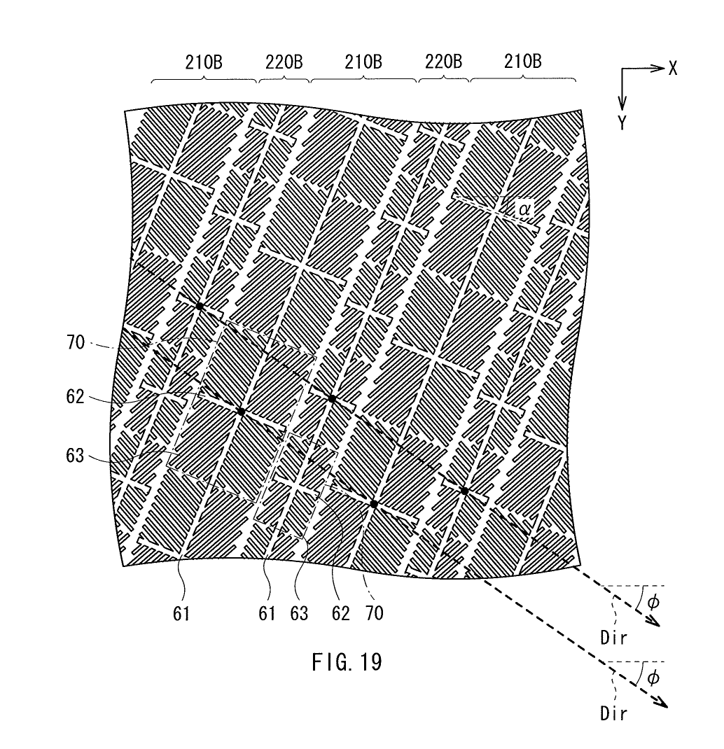

FIG. 19 shows a configuration example of transparent electrodes 210B and 220B related to a stereoscopic display device 2B according to this modification. The stem portions 62 are formed to extend in the direction forming a given angle α from the horizontal direction X. The sub-electrode regions 70 on adjoining transparent electrodes 210B are arrayed in the direction forming a given angle φ from the horizontal direction X (array direction Dir), and the sub-electrode regions 70 on the adjoining transparent electrodes 220B are also arrayed in the array direction Dir as with the sub-electrode regions 70 on the adjoining transparent electrodes 210B. Such a structure also allows any moire to be made less noticeable, enabling to enhance a degree of freedom in design.

### (Modification 2-2)

According to the above-described embodiment of the present disclosure, the array direction of the sub-electrode regions 270 on the adjoining transparent electrodes 210 and the array direction of the sub-electrode regions 270 on the adjoining transparent electrodes 220 are set to be the same, although the embodiment is not limited thereto. Alternatively, for example, the array direction of the sub-electrode regions 270 on the adjoining transparent electrodes 210 and the array direction of the sub-electrode regions 270 on the adjoining transparent electrodes 220 may be set to be different from each other. Such an example is described hereinafter.

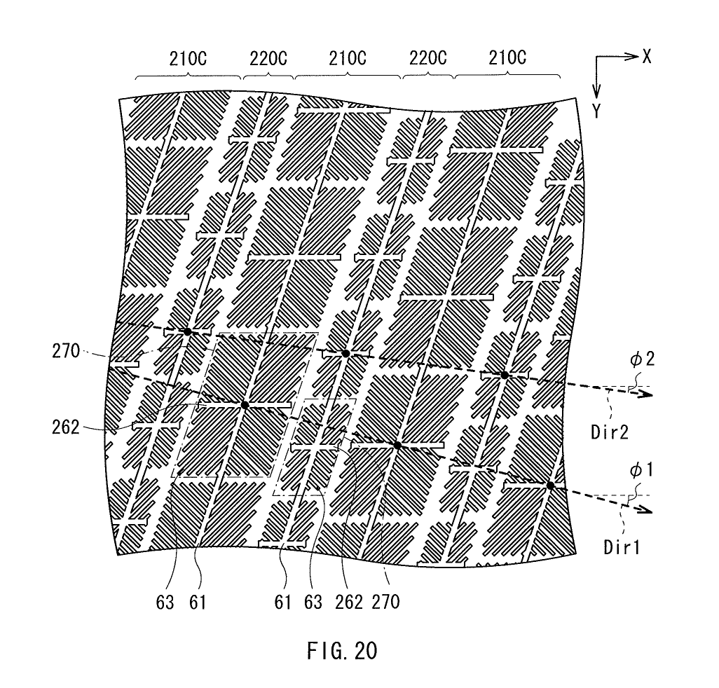

FIG. 20 shows a configuration example of transparent electrodes 210C and 220C related to a stereoscopic display device 2C according to this modification. On the stereoscopic display device 2C, the sub-electrode regions 270 on adjoining transparent electrodes 210C are arrayed in the direction forming a given angle φ1 from the horizontal direction X (array direction Dir1), and the sub-electrode regions 270 on the adjoining transparent electrodes 220C are arrayed in the direction forming a given angle φ2 from the horizontal direction X (array direction Dir2).

On the stereoscopic display device 2C according to this modification, since the sub-electrode regions 270 on the transparent electrodes 210C related to the opening-closing sections 11 are arrayed in the array direction Dir1, borderlines LB1 related to the opening-closing sections 11 extend in the array direction Dir1. Similarly, since the sub-electrode regions 270 on the transparent electrodes 220C related to the opening-closing sections 12 are arrayed in the array direction Dir2, borderlines LB2 related to the opening-closing sections 12 extend in the array direction Dir2. On the stereoscopic display device 2C, therefore, in performing the stereoscopic display operation, since the borderlines LB2 related to the opening-closing sections 12 extend in the array direction Dir2, this makes it possible to reduce interference between the borderlines LB2 and the light-shielding lines LBM on the display section 20 that extend in the horizontal direction X, thereby allowing any moire to be made less noticeable. Further, in performing the normal display (two-dimensional display) operation, since the borderlines LB2 related to the opening-closing sections 12 extend in the array direction Dir2, and in addition the borderlines LB1 related to the opening-closing sections 11 extend in the array direction Dir1, this makes it possible to reduce interference among the borderlines LB1 and LB2 and the light-shielding lines LBM on the display section 20 that extend in the horizontal direction X, thereby allowing any moire to be made less noticeable.

### 3. Third Embodiment

Next, the description is provided on a stereoscopic display device 3 according to a third embodiment of the present disclosure. In the third embodiment of the present disclosure, the liquid crystal barrier according to the first embodiment of the present disclosure is applied to a so-called pinhole-type liquid crystal barrier. It is to be noted that any component parts essentially same as the stereoscopic display device 1 according to the first embodiment of the present disclosure are denoted with the same reference numerals, and the related descriptions are omitted as appropriate.

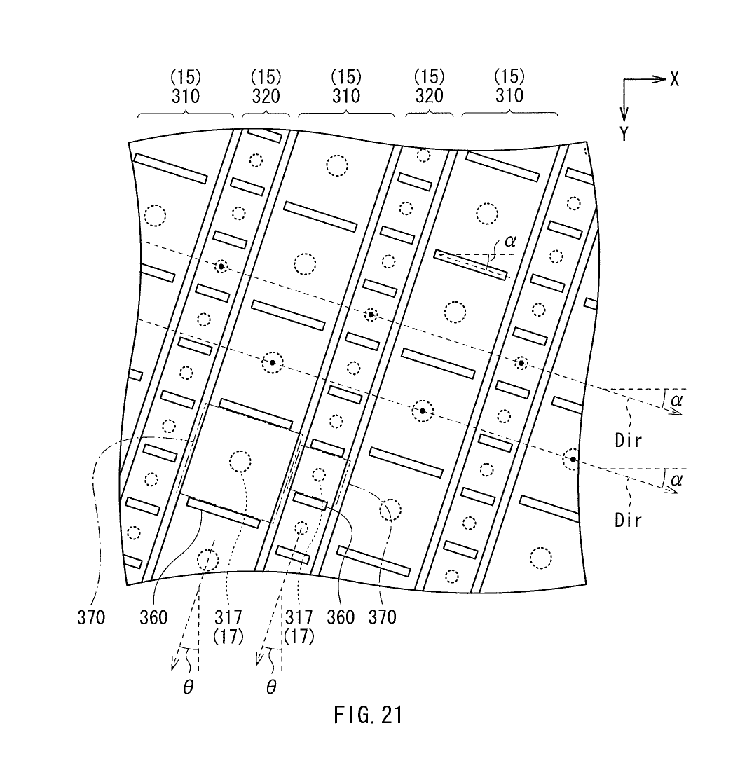

FIG. 21 shows a configuration example of transparent electrodes on transparent electrode layers 15 and 17 related to the stereoscopic display device 3 according to the third embodiment of the present disclosure. The transparent electrode layer 15 has transparent electrodes 310 and 320. On each of the transparent electrodes 310 and 320, sub-electrode regions 370 are placed side by side along the same direction as the extending direction of the opening-closing sections 11 and 12 (direction forming a given angle θ from the vertical direction Y). For the transparent electrodes 310 and 320, electrodes are formed over a whole surface within the sub-electrode regions 370, and slits 360 extending in the direction forming a given angle α from the horizontal direction X are formed at border portions of the sub-electrode regions 370 adjoining to each other in the extending direction of the opening-closing sections 11 and 12. Further, on the transparent electrode layer 17, a hole 317 is formed at a position corresponding to the vicinity of a center of each sub-electrode region 370. That is, the liquid crystal barrier according to this modification is of a so-called pinhole-type. It is to be noted that, in FIG. 21, the angle α is almost equal to the angle θ formed between the extending direction of the opening-closing sections 11 and 12 and the vertical direction Y, although the angle α is not limited thereto. Alternatively, the angle α may be equal to, or different from the angle θ.

The sub-electrode regions 370 on the adjoining transparent electrodes 310 are arrayed in the same direction as the extending direction of the slits 360 (array direction Dir), and the sub-electrode regions 370 on the adjoining transparent electrodes 320 are also arrayed in the array direction Dir as with the sub-electrode regions 370 on the adjoining transparent electrodes 310.

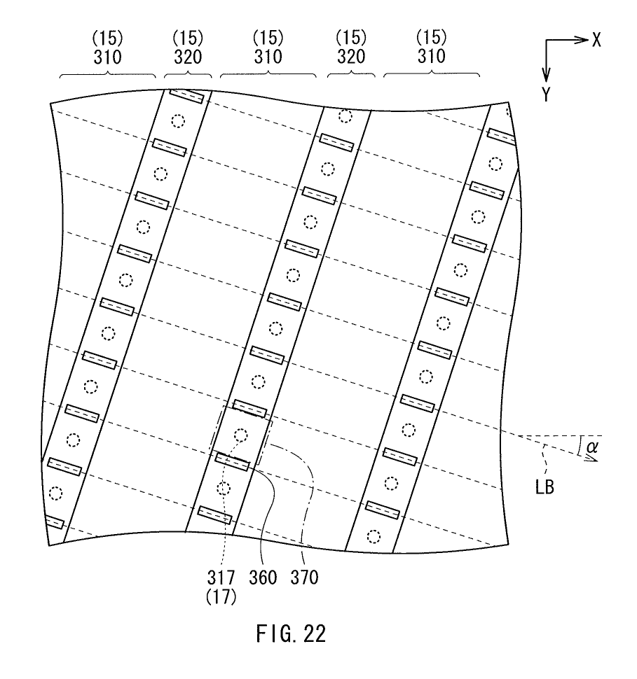

FIG. 22 shows a configuration example of the transparent electrode 320. As shown in FIG. 21, since the sub-electrode regions 370 on the adjoining transparent electrodes 320 are arrayed in the direction forming a given angle α from the horizontal direction X (array direction Dir), the slits 360 are disposed on a single straight line (on the borderline LB) extending in the array direction Dir as shown in FIG. 22. At portions of the slits 360, even though a voltage is applied between the transparent electrode layer 17 and the transparent electrode 320, the alignment of liquid crystal molecules on the liquid crystal layer 19 becomes insufficient, and thus light may not be transmitted adequately. More specifically, the borderline LB becomes so-called a dark line.

It is to be noted that the above description is only provided on the transparent electrode 320, although the transparent electrode 310 holds true as well, wherein the slits 360 on the transparent electrodes 310 are also disposed on a single straight line extending in the array direction Dir.

In such a manner, on the stereoscopic display device 3 according to the third embodiment of the present disclosure, the sub-electrode regions 370 on the adjoining transparent electrodes 320 (310) are arrayed in the direction forming a given angle α from the horizontal direction X (array direction Dir), and thus the borderlines LB extend in the array direction Dir. This makes it possible to reduce interference between the borderlines LB and the light-shielding lines LBM on the display section 20 that extend in the horizontal direction X, thereby allowing any moire to be made less noticeable.

As described above, in the third embodiment of the present disclosure, the sub-electrode regions on the adjoining transparent electrodes 320 (310) are arrayed in the direction forming a given angle α from the horizontal direction X on the pinhole-type liquid crystal barrier, which allows any moire to be made less noticeable. Any other advantageous effects are the same as with the above-described first embodiment.

### [Modification 3-1]

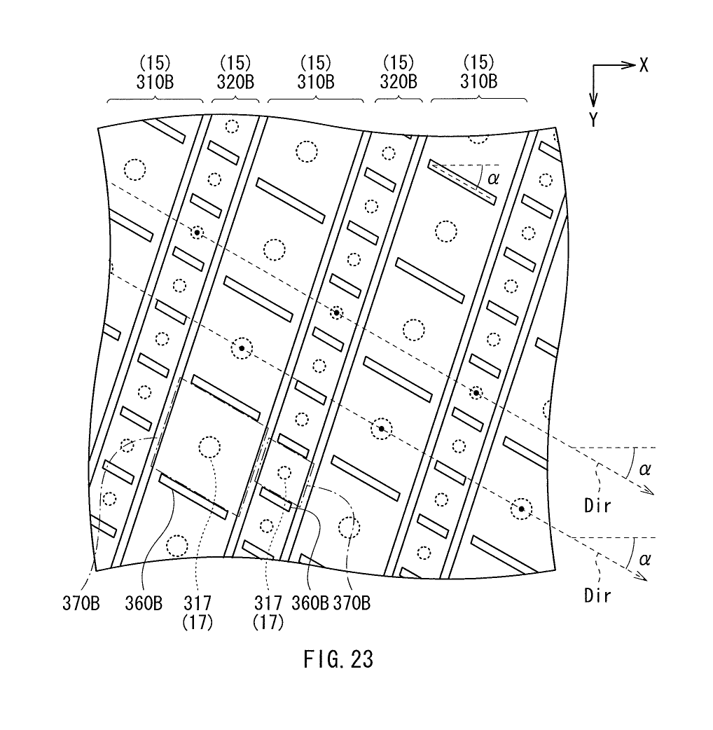

According to the above-described embodiment of the present disclosure, the angle α is almost equal to the angle θ, although the angle α is not limited thereto. Alternatively, as shown in FIG. 23, the angle α may be different from the angle θ.

### 4. Fourth Embodiment

Next, the description is provided on a stereoscopic display device 4 according to a fourth embodiment of the present disclosure. In the fourth embodiment of the present disclosure, the liquid crystal barrier according to the second embodiment of the present disclosure is applied to a pinhole-type liquid crystal barrier. It is to be noted that any component parts essentially same as the stereoscopic display devices 2 and 3 are denoted with the same reference numerals, and the related descriptions are omitted as appropriate.

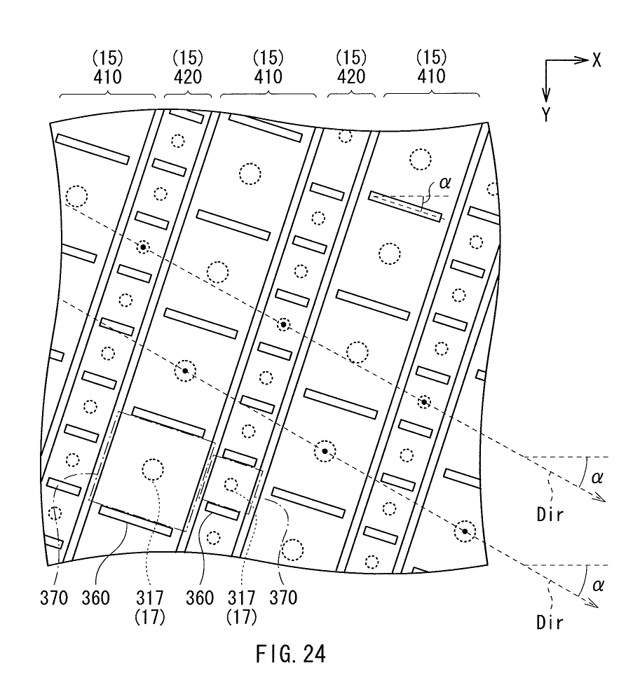

FIG. 24 shows a configuration example of transparent electrodes 410 and 420 related to the stereoscopic display device 4 according to the fourth embodiment of the present disclosure. The slits 360 are formed to extend in the direction forming a given angle α from the horizontal direction X. The sub-electrode regions 370 on the adjoining transparent electrodes 410 are arrayed in the direction forming a given angle φ from the horizontal direction X (array direction Dir), and the sub-electrode regions 370 on the adjoining transparent electrodes 420 are also arrayed in the array direction Dir as with the sub-electrode regions 370 on the adjoining transparent electrodes 410.

With such an arrangement, on the stereoscopic display device 4 according to the fourth embodiment of the present disclosure, the slits 360 are formed to extend in the direction forming a given angle α from the horizontal direction X, and the sub-electrode regions 370 are arrayed in the direction forming a given angle φ from the horizontal direction X (array direction Dir). As a result, on the stereoscopic display device 4 according to the fourth embodiment of the present disclosure, borderlines LB extend in the array direction Dir. This makes it possible to reduce interference between the borderlines LB and the light-shielding lines LBM on the display section 20 that extend in the horizontal direction X, thereby allowing any moire to be made less noticeable. Further, according to the fourth embodiment of the present disclosure, it is possible to set the extending direction of the slits 360 and the array direction Dir of the sub-electrode regions 370 independently of each other, which ensures to enhance a degree of freedom in design.

As described above, in the fourth embodiment of the present disclosure, the array directions of the slits and the sub-electrode regions are set independently of each other on the pinhole-type liquid crystal barrier, which ensures to enhance a degree of freedom in design. Any other advantageous effects are the same as with the above-described first embodiment.

### [Modification 4-1]

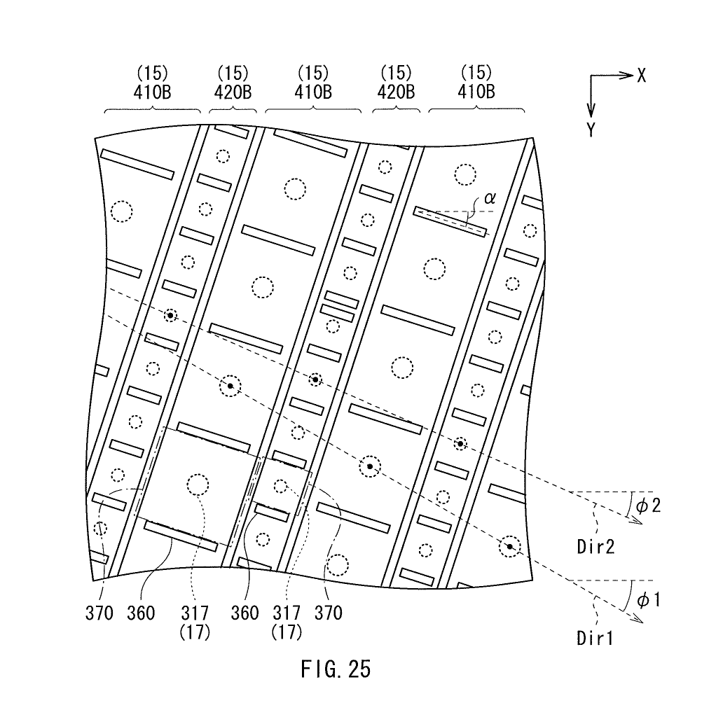

According to the above-described embodiment of the present disclosure, the array direction of the sub-electrode regions 370 on the adjoining transparent electrodes 410 and the array direction of the sub-electrode regions 370 on the adjoining transparent electrodes 420 are set to be the same, although the embodiment is not limited thereto. Alternatively, for example, as with the modification 2-2 for the above-described second embodiment, the array direction of the sub-electrode regions 370 on the adjoining transparent electrodes 410 and the array direction of the sub-electrode regions 370 on the adjoining transparent electrodes 420 may be set to be different from each other. Such an example is shown in FIG. 25. Such a structure also enables any moire to be made less noticeable.

The present technology is described hereto by citing several embodiments and modifications, although the present technology is not limited to those embodiments and the like, and a variety of modifications are available.

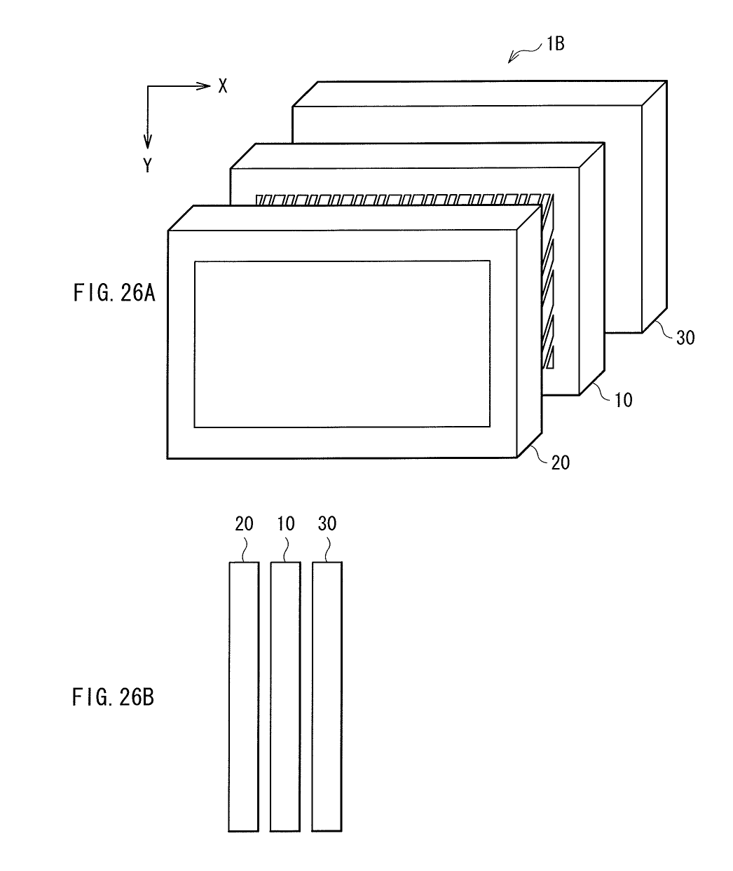

For example, in the above-described embodiments and the like, the backlight 30, the display section 20, and the liquid crystal barrier section 10 on the stereoscopic display device 1 are disposed in this order, although the arrangement is not limited thereto. Alternatively, as shown in FIGS. 26A and 26B, the arrangement in the order of the backlight 30, the liquid crystal barrier section 10, and the display section 20 may be applicable.

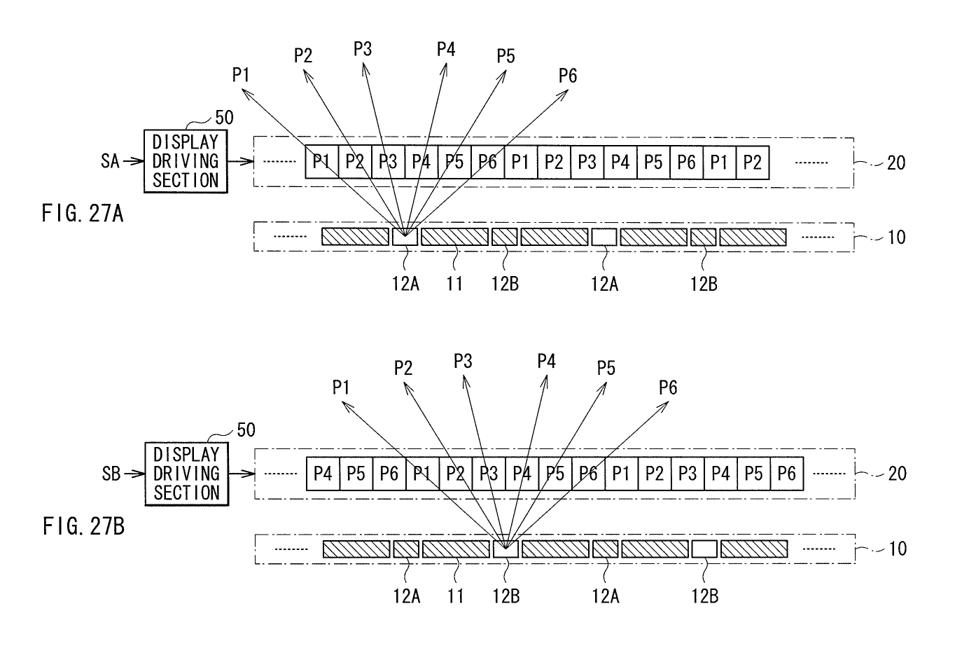

FIGS. 27A and 27B each show an operation example of the display section 20 and the liquid crystal barrier section 10 according to this modification, wherein FIG. 27A denotes a case where the image signal SA is provided, while FIG. 27B denotes a case where the image signal SB is provided. In this modification, the light projected from the backlight 30 comes into the liquid crystal barrier section 10 at first. Thereafter, the light transmitting through the opening-closing sections 12A and 12B among such light beams is modulated on the display section 20, while six perspective images being output.

Further, for example, in the above-described embodiments and the like, the opening-closing sections 12 compose two groups, although the configuration is not limited thereto. Alternatively, the opening-closing sections 12 may compose three or more groups (barrier sub-groups). This allows the display resolution to be further improved. The detailed description is provided hereinafter.

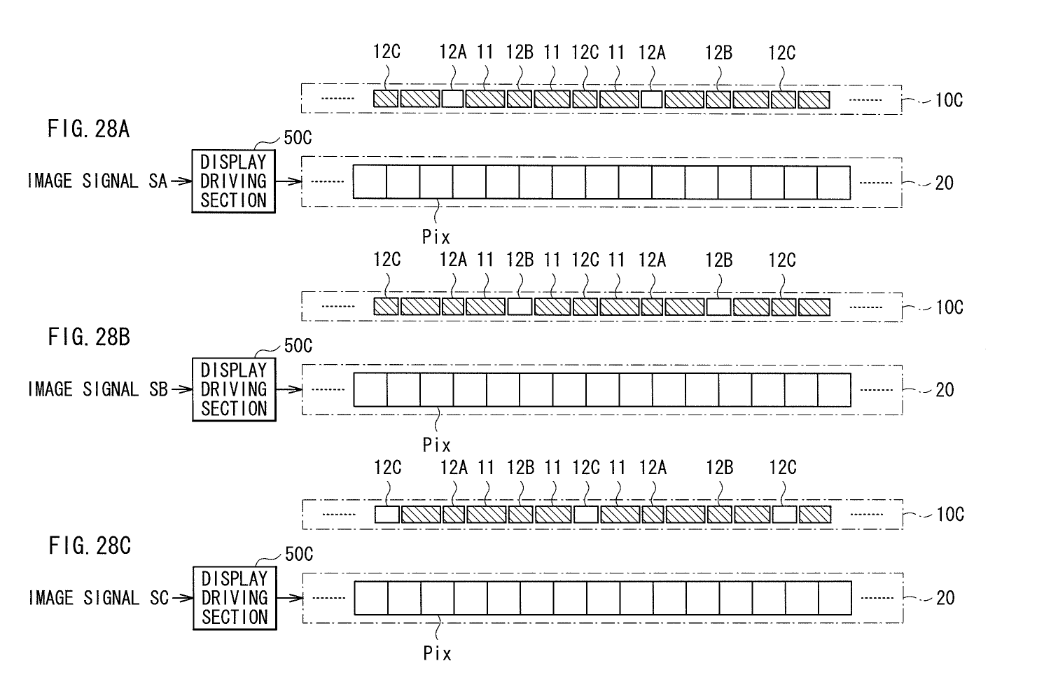

FIGS. 28A to 28C each show a case where the opening-closing sections 12 compose three groups A, B, and C. As with the above-described embodiment, the opening-closing sections 12A indicate the opening-closing sections 12 belonging to the group A, and the opening-closing sections 12B indicate the opening-closing sections 12 belonging to the group B, while the opening-closing sections 12C indicate the opening-closing sections 12 belonging to the group C.

With such an arrangement, by displaying images with the opening-closing sections 12A, 12B, and 12C open alternately on the time-division basis, the stereoscopic display device according to this modification is capable of achieving the resolution three times as high as a case where the opening-closing sections 12A are only provided. In other words, the resolution required for this stereoscopic display device is a half (=⅙×3) as compared with a case of the two-dimensional display.

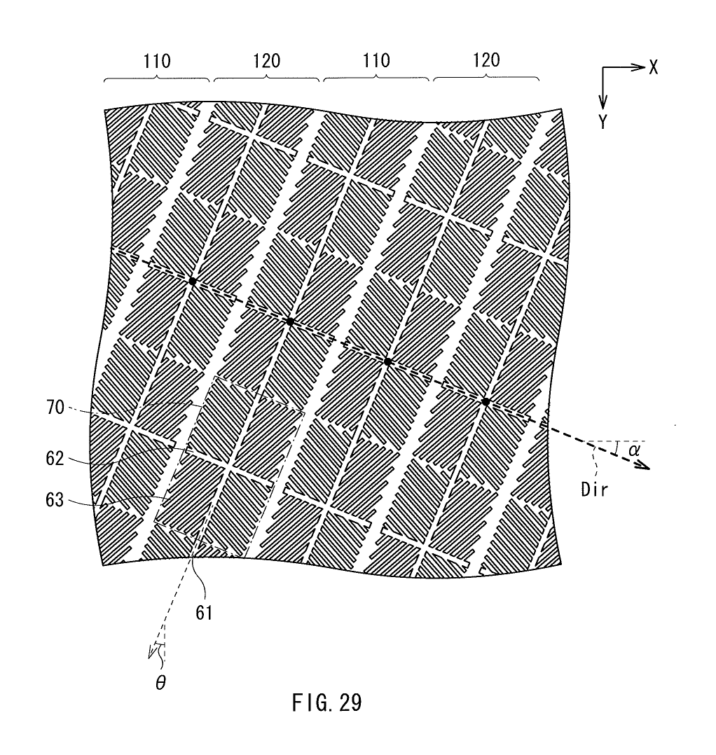

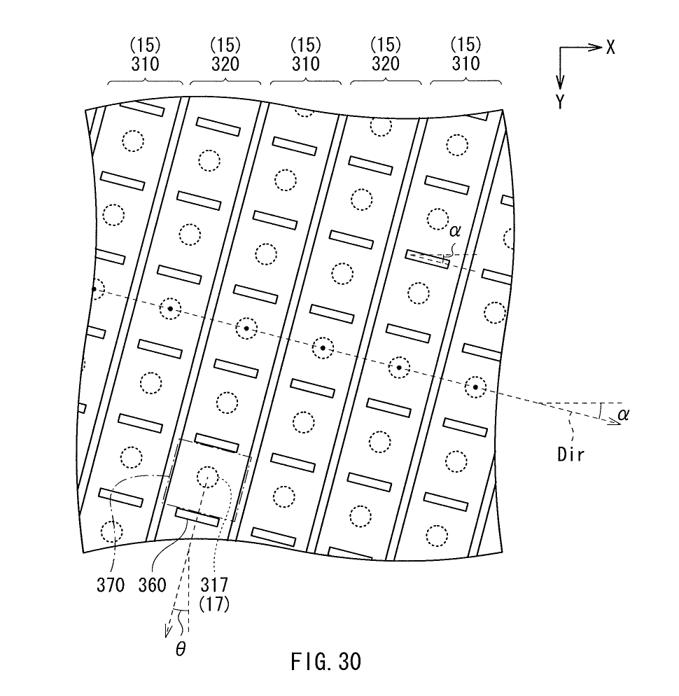

Further, for example, in the above-described embodiments and the like, an illustration is given in the figure as an example under the condition that the width E1 of the opening-closing section 11 is greater than the width E2 of the opening-closing section 12 (E1>E2), although the width magnitude relation is not limited thereto. Alternatively, the width E1 of the opening-closing section 11 may be equal to the width E2 of the opening-closing section 12 (E1=E2), or the width E1 of the opening-closing section 11 may be smaller than the width E2 of the opening-closing section 12 (E1<E2). FIG. 29 and FIG. 30 show examples of the case where the width E1 of the opening-closing section 11 is made equal to the width E2 of the opening-closing section 12 (E1=E2) on the stereoscopic display device 1 according to the first embodiment and the stereoscopic display device 3 according to the third embodiment, respectively.

In addition, for example, in the above-described embodiments and the like, the sub-electrode regions are placed side by side in the extending direction of the opening-closing sections 11 and the opening-closing sections 12, while being arrayed in the array direction Dir, although the arrangement is not limited thereto. Alternatively, for example, the sub-electrode regions may be adjacent to each other in the random direction. In such a case, it is not necessary that all the sub-electrode regions should be adjacent to each other in the direction different from the horizontal direction X and the vertical direction Y, and alternatively some of the sub-electrode regions may be adjacent to each other in the horizontal direction X and the vertical direction Y. In this case, the domain borderline LD or the borderline LB itself does not form a straight line, which makes it possible to reduce any moire.

Moreover, for example, in the above-described embodiments and the like, the image signals SA and SB include six perspective images, although the signal assignment is not limited thereto. Alternatively, the image signals SA and SB may include five or less perspective images, or seven or more perspective images. In this case, a relationship between the opening-closing sections 12A and 12B on the liquid crystal barrier section 10 and the pixels Pix as shown in FIGS. 10A to 10C are also varied. More specifically, for example, when the image signals SA and SB include five perspective images, it is desirable to provide the opening-closing sections 12A at a rate of one piece per five pixels Pix on the display section 20, while similarly it is desirable to provide the opening-closing sections 12B at a rate of one piece per five pixels Pix on the display section 20 as well.

Further, for example, in the above-described embodiments and the like, the opening-closing sections 12 compose a plurality of groups, although the configuration is not limited thereto. Alternatively, the opening-closing sections 12 may not compose a group, but all the opening-closing sections 12 may be kept open during the stereoscopic display.

Additionally, for example, in the above-described embodiments and the like, the display section 20 is a liquid crystal display section, although the arrangement is not limited thereto. Alternatively, an EL (Electro Luminescence) display section using organic EL for example may be used. Such a case eliminates the need for use of the backlight driving section 42 and the backlight 30 as shown in FIG. 1.

Thus, it is possible to achieve at least the following configurations from the above-described example embodiments and the modifications of the disclosure.

(1) A display device, including:

a display section displaying an image; and

a liquid crystal barrier section including a liquid crystal layer and a plurality of sub-electrodes, and including a plurality of liquid crystal barriers extending in a first direction, each of the liquid crystal barriers allowing light to transmit therethrough and blocking the light, and the liquid crystal barriers structuring at least one group of the liquid crystal barriers,

wherein the sub-electrodes, belonging to a first liquid crystal barrier of a pair of the liquid crystal barriers, adjoin, in a second direction, the sub-electrodes belonging to a second liquid crystal barrier in the pair of the liquid crystal barriers, the pair of the liquid crystal barriers being adjacent to each other in the at least one group of the liquid crystal barriers, and the second direction being different from both of a vertical direction and a horizontal direction within a display plane of the display section.

(2) The display device according to (1), wherein

the liquid crystal barriers structure a first group of the liquid crystal barriers and a second group of the liquid crystal barriers, and

the sub-electrodes, belonging to a first liquid crystal barrier of a pair of the liquid crystal barriers adjacent to each other in a same group of the liquid crystal barriers in the first and the second groups, adjoin, in the second direction, the sub-electrodes belonging to a second liquid crystal barrier in the pair of the liquid crystal barriers in the same group of the liquid crystal barriers.

(3) The display device according to (2), wherein the sub-electrodes are arrayed in the second direction in regions corresponding to the liquid crystal barriers in the same group of the liquid crystal barriers.
(4) The display device according to any one of (1) to (3), wherein each of the sub-electrodes has a region surrounded by four sides, and includes a first stem portion, a second stem portion, and a plurality of branch portions, the first stem portion extending in the first direction, the second stem portion extending in a third direction intersecting with the first stem portion, and the branch portions extending in a direction away from both the first stem portion and the second stem portion, and wherein two sides facing the first direction among the four sides extend in the third direction.
(5) The display device according to (4), wherein the third direction substantially agrees with the second direction.
(6) The display device according to (4), wherein the third direction substantially agrees with the horizontal direction.
(7) The display device according to any one of (4) to (6), wherein the branch portions extend in a same direction within each of a first branch region, a second branch region, a third branch region, and a fourth branch region, the first branch region and the second branch region being disposed on one side of the first stem portion with the second stem portion interposed in between, the third branch region being disposed on an opposite side of the first branch region relative to the first stem portion, and the fourth branch region being disposed on an opposite side of the second branch region relative to the first stem portion.
(8) The display device according to (7), further including:

a first polarizer provided on a first side of the liquid crystal layer and allowing light polarized in one direction of the vertical direction and the horizontal direction to transmit therethrough; and

a second polarizer provided on a second side of the liquid crystal layer and allowing light polarized in the other direction of the vertical direction and the horizontal direction to transmit therethrough, the second side being a side opposite to the first side of the liquid crystal layer provided with the first polarizer,

wherein the branch portions in the first branch region and the branch portions in the fourth branch region extend in a direction inclined at about 45 degrees counterclockwise from the horizontal direction, and the branch portions in the second branch region and the branch portions in the third branch region extend in a direction inclined at about 45 degrees clockwise from the horizontal direction.

(9) The display device according to any one of (4) to (8), wherein the liquid crystal barrier section includes a common electrode provided in common over a region corresponding to the liquid crystal barriers, on an opposite side of the sub-electrodes with the liquid crystal layer interposed in between.
(10) The display device according to any one of (1) to (3), wherein the liquid crystal barrier section includes a common electrode provided in common over a region corresponding to the liquid crystal barriers, on an opposite side of the sub-electrodes with the liquid crystal layer interposed in between, the common electrode having a hole provided corresponding to each of the sub-electrodes.
(11) The display device according to (10), wherein the liquid crystal barrier section includes a slit between the sub-electrodes adjacent to each other in the first direction, the slit extending in a third direction.
(12) The display device according to (11), wherein the third direction is substantially the second direction.
(13) The display device according to any one of (1) to (12), wherein the first direction is different from both of the vertical direction and the horizontal direction.
(14) The display device according to any one of (1) to (13), wherein the sub-electrodes adjacent to each other in the first direction are electrically connected with each other.
(15) The display device according to (3), wherein the second direction is equal between the first group of the liquid crystal barriers and the second group of the liquid crystal barriers.
(16) The display device according to (3), wherein the second direction is different between the first group of the liquid crystal barriers and the second group of the liquid crystal barriers.
(17) The display device according to (2) or (3), wherein

a plurality of display modes are included, the display modes including a three-dimensional image display mode and a two-dimensional image display mode,

the display section displays a plurality of different perspective images, and the liquid crystal barriers belonging to the first group of the liquid crystal barriers are in a transmission state and the liquid crystal barriers belonging to the second group of the liquid crystal barriers are in a blocking state, to allow a three-dimensional image to be displayed in the three-dimensional image display mode, and

the display section displays a single perspective image, and the liquid crystal barriers belonging to the first group of the liquid crystal barriers as well as the liquid crystal barriers belonging to the second group of the liquid crystal barriers are in the transmission state, to allow a two-dimensional image to be displayed in the two-dimensional image display mode.

(18) The display device according to (17), wherein the liquid crystal barriers belonging to the first group of the liquid crystal barriers are grouped into a plurality of barrier sub-groups, and are switched between the transmission state and the blocking state on a time-divisional basis for each of the barrier sub-groups in the three-dimensional image display mode.
(19) The display device according to any one of (1) to (18), further including a backlight,

wherein the display section is a liquid crystal display section disposed between the backlight and the liquid crystal barrier section.

(20) The display device according to any one of (1) to (18), further including a backlight,

wherein the display section is a liquid crystal display section, and

the liquid crystal barrier section is disposed between the backlight and the liquid crystal display section.

(21) A display device, including:

a display section including a black matrix; and

a liquid crystal barrier section including a liquid crystal layer and a plurality of sub-electrodes, and including a plurality of liquid crystal barriers, each of the liquid crystal barriers allowing light to transmit therethrough and blocking the light,

wherein each of the sub-electrodes has a region surrounded by four sides, and each of the four sides extends in a direction different from the black matrix of the display section.

(22) A barrier device, including:

a plurality of liquid crystal barriers extending in a first direction and disposed away from a display plane of a display section that displays an image, the liquid crystal barriers including a liquid crystal layer and a plurality of sub-electrodes and allowing light to transmit therethrough and blocking the light, and the liquid crystal barriers structuring at least one group of the liquid crystal barriers,

wherein the sub-electrodes, belonging to a first liquid crystal barrier of a pair of the liquid crystal barriers, adjoin, in a second direction, the sub-electrodes belonging to a second liquid crystal barrier in the pair of the liquid crystal barriers, the pair of the liquid crystal barriers being adjacent to each other in the at least one group of the liquid crystal barriers, and the second direction being different from both of a vertical direction and a horizontal direction within the display plane of the display section.

The present disclosure contains subject matter related to that disclosed in Japanese Priority Patent Application JP 2011-094163 filed in the Japan Patent Office on Apr. 20, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a display section displaying an image; and
a liquid crystal barrier section including a liquid crystal layer and a plurality of sub-electrodes, and including a plurality of liquid crystal barriers extending in a first direction, each of the liquid crystal barriers allowing light to transmit therethrough and blocking the light, and the liquid crystal barriers structuring at least one group of the liquid crystal barriers,
wherein the sub-electrodes, belonging to a first liquid crystal barrier of a pair of the liquid crystal barriers, adjoin, in a second direction, the sub-electrodes belonging to a second liquid crystal barrier in the pair of the liquid crystal barriers, the pair of the liquid crystal barriers being adjacent to each other in the at least one group of the liquid crystal barriers, and the second direction being different from both of a vertical direction and a horizontal direction within a display plane of the display section.

2. The display device according to claim 1, wherein
the liquid crystal barriers structure a first group of the liquid crystal barriers and a second group of the liquid crystal barriers, and
the sub-electrodes, belonging to a first liquid crystal barrier of a pair of the liquid crystal barriers adjacent to each other in a same group of the liquid crystal barriers in the first and the second groups, adjoin, in the second direction, the sub-electrodes belonging to a second liquid crystal barrier in the pair of the liquid crystal barriers in the same group of the liquid crystal barriers.

3. The display device according to claim 2, wherein the sub-electrodes are arrayed in the second direction in regions corresponding to the liquid crystal barriers in the same group of the liquid crystal barriers.

4. The display device according to claim 1, wherein each of the sub-electrodes has a region surrounded by four sides, and includes a first stem portion, a second stem portion, and a plurality of branch portions, the first stem portion extending in the first direction, the second stem portion extending in a third direction intersecting with the first stem portion, and the branch portions extending in a direction away from both the first stem portion and the second stem portion, and wherein two sides facing the first direction among the four sides extend in the third direction.

5. The display device according to claim 4, wherein the third direction substantially agrees with the second direction.

6. The display device according to claim 4, wherein the third direction substantially agrees with the horizontal direction.

7. The display device according to claim 4, wherein the branch portions extend in a same direction within each of a first branch region, a second branch region, a third branch region, and a fourth branch region, the first branch region and the second branch region being disposed on one side of the first stem portion with the second stem portion interposed in between, the third branch region being disposed on an opposite side of the first branch region relative to the first stem portion, and the fourth branch region being disposed on an opposite side of the second branch region relative to the first stem portion.

8. The display device according to claim 7, further comprising:
a first polarizer provided on a first side of the liquid crystal layer and allowing light polarized in one direction of the vertical direction and the horizontal direction to transmit therethrough; and
a second polarizer provided on a second side of the liquid crystal layer and allowing light polarized in the other direction of the vertical direction and the horizontal direction to transmit therethrough, the second side being a side opposite to the first side of the liquid crystal layer provided with the first polarizer,
wherein the branch portions in the first branch region and the branch portions in the fourth branch region extend in a direction inclined at about 45 degrees counterclockwise from the horizontal direction, and the branch portions in the second branch region and the branch portions in the third branch region extend in a direction inclined at about 45 degrees clockwise from the horizontal direction.

9. The display device according to claim 4, wherein the liquid crystal barrier section includes a common electrode provided in common over a region corresponding to the liquid crystal barriers, on an opposite side of the sub-electrodes with the liquid crystal layer interposed in between.

10. The display device according to claim 1, wherein the liquid crystal barrier section includes a common electrode provided in common over a region corresponding to the liquid crystal barriers, on an opposite side of the sub-electrodes with the liquid crystal layer interposed in between, the common electrode having a hole provided corresponding to each of the sub-electrodes.

11. The display device according to claim 10, wherein the liquid crystal barrier section includes a slit between the sub-electrodes adjacent to each other in the first direction, the slit extending in a third direction.

12. The display device according to claim 11, wherein the third direction is substantially the second direction.

13. The display device according to claim 1, wherein the first direction is different from both of the vertical direction and the horizontal direction.

14. The display device according to claim 1, wherein the sub-electrodes adjacent to each other in the first direction are electrically connected with each other.

15. The display device according to claim 3, wherein the second direction is equal between the first group of the liquid crystal barriers and the second group of the liquid crystal barriers.

16. The display device according to claim 3, wherein the second direction is different between the first group of the liquid crystal barriers and the second group of the liquid crystal barriers.

17. The display device according to claim 2, wherein
a plurality of display modes are included, the display modes including a three-dimensional image display mode and a two-dimensional image display mode,
the display section displays a plurality of different perspective images, and the liquid crystal barriers belonging to the first group of the liquid crystal barriers are in a transmission state and the liquid crystal barriers belonging to the second group of the liquid crystal barriers are in a blocking state, to allow a three-dimensional image to be displayed in the three-dimensional image display mode, and
the display section displays a single perspective image, and the liquid crystal barriers belonging to the first group of the liquid crystal barriers as well as the liquid crystal barriers belonging to the second group of the liquid crystal barriers are in the transmission state, to allow a two-dimensional image to be displayed in the two-dimensional image display mode.

18. The display device according to claim 17, wherein the liquid crystal barriers belonging to the first group of the liquid crystal barriers are grouped into a plurality of barrier sub-groups, and are switched between the transmission state and the blocking state on a time-divisional basis for each of the barrier sub-groups in the three-dimensional image display mode.

19. The display device according to claim 1, further comprising a backlight,
wherein the display section is a liquid crystal display section disposed between the backlight and the liquid crystal barrier section.

20. The display device according to claim 1, further comprising a backlight,
wherein the display section is a liquid crystal display section, and
the liquid crystal barrier section is disposed between the backlight and the liquid crystal display section.

21. A display device, comprising:
a display section including a black matrix; and
a liquid crystal barrier section including a liquid crystal layer and a plurality of sub-electrodes, and including a plurality of liquid crystal barriers, each of the liquid crystal barriers allowing light to transmit therethrough and blocking the light,
wherein each of the sub-electrodes has a region surrounded by four sides, and each of the four sides extends in a direction different from the black matrix of the display section.

22. A barrier device, comprising:
a plurality of liquid crystal barriers extending in a first direction and disposed away from a display plane of a display section that displays an image, the liquid crystal barriers including a liquid crystal layer and a plurality of sub-electrodes and allowing light to transmit therethrough and blocking the light, and the liquid crystal barriers structuring at least one group of the liquid crystal barriers,
wherein the sub-electrodes, belonging to a first liquid crystal barrier of a pair of the liquid crystal barriers, adjoin, in a second direction, the sub-electrodes belonging to a second liquid crystal barrier in the pair of the liquid crystal barriers, the pair of the liquid crystal barriers being adjacent to each other in the at least one group of the liquid crystal barriers, and the second direction being different from both of a vertical direction and a horizontal direction within the display plane of the display section.
